(19) United States
(12) Patent Application Publication
(10) Pub. No.: US 2013/0194238 A1
(43) Pub. Date: Aug. 1, 2013

(54) INFORMATION PROCESSING DEVICE, INFORMATION PROCESSING METHOD, AND COMPUTER PROGRAM

(71) Applicant: Sony Corporation, Tokyo (JP)

(72) Inventor: Yusuke Sakai, Kanagawa (JP)

(73) Assignee: SONY CORPORATION, Tokyo (JP)

(21) Appl. No.: 13/734,019

(22) Filed: Jan. 4, 2013

(30) Foreign Application Priority Data
Jan. 13, 2012 (JP) 2012-005327

(51) Int. Cl. G06F 3/042

(52) U.S. Cl. CPC G06F 3/0425
USPC 345/175

(57) ABSTRACT

An information processing device includes a display unit; an object image obtaining unit configured to obtain images of objects to be displayed on the screen of the display unit; a real size obtaining unit configured to obtain information related to the real size of the objects to be displayed on the screen of the display unit; and a calculating unit configured to process the images of the objects, based on the real size of the objects obtained by the real size obtaining unit.

### CROSS-REFERENCE TO RELATED APPLICATION

The present application claims priority from Japanese Patent Application No. JP 2012-005327 filed in the Japanese Patent Office on Jan. 13, 2012, the entire content of which is incorporated herein by reference.

### BACKGROUND

The technology disclosed in the present specification relates to an information processing device, information processing method, and computer program, that has a display screen that also functions as an input unit, such as a touch panel or the like, and more specifically, it relates to an information processing device, an information processing method, and computer program, whereby a large screen is implemented to enable multiple users to share and operate a touch panel so that the users can perform collaborative work.

Recently, tablet terminals that have a display screen that also functions as an input unit, such as a touch panel or the like have been spreading rapidly. Tablet terminals have widget and desktop interfaces, and due to the operating method being easy to understand visually, allow the user to use these terminals more easily than personal computers, whose input operations are performed with a keyboard and mouse.

For example, there has been proposed a touch sensitive device that reads data belonging to touch input relating to the touch sensitive device, from a multi-point detection device such as a multi-point touch screen, and identifies multi-point gestures, based on data from the multi-point detection device (refer to Japanese Unexamined Patent Application Publication No. 2010-170573).

Generally, multiple operable objects that serve as user operation targets are arranged in various orientations on the screen of tablet terminals. These individual operable objects are playable content such as moving images and still images, emails and messages received from other users, and so forth. In order to display the desired operable object directly to themselves, the user have to rotate the tablet terminal main unit. If the tablet terminal is around the size of a standard or letter-size sheet of paper, for example, then it is easy to rotate. However when dealing with large screens tens of inches in size, it is difficult for a single user to rotate the tablet terminal when operating an operable object.

Another conceivable usage case is to have multiple users simultaneously perform operations on their own respective individual operable objects on a tablet terminal with a large screen.

There has been proposed, for example, a tablet terminal that detects a user's presence at the edge of the tablet terminal via a proximity sensor, identifies a space between the right arm and left arm, and maps to that user's touch-point region (refer to http://www.autodeskresearch.com/publications/medusa). When the tablet terminal detects multiple users, by setting the operational rights of each individual user for each operable object, and preventing additional user participation beforehand, operations can be inhibited such as when a certain user is operating an operable object, and a different user rotates the terminal to directly face themselves.

However, as a usage case in which multiple users share a tablet terminal with a large screen, in addition to the case of each user performing operation on operable objects individually, a case is assumed in which users perform collaborative work by interchanging operable objects. It is difficult to realize this collaborative work, as the touch point region occupied by each user have to be set, and the operation of operable objects have to be given operational rights within each individual region to be performed.

Also, if the GUI displayed on the terminal screen is fixed and not dependent on the distance between the user and the screen or the user state, such problems occur as when the user is far and does not understand the displayed information that is too small on the screen, or when the user is close and the amount of information displayed on the screen is too little. Similarly, if the input method that allows the user to operate the terminal is fixed and not dependent on the distance between the user and the screen or the user state, such inconveniences can occur as the user not being able to operate the terminal even though being close to the terminal because there is no remote control, or the user have to be close to the terminal in order to operate the touch panel.

Also, with physical display systems according to the related art, actual object images are displayed on the screen without considering real size information for the object. Accordingly, there is a problem in that the size of objects displayed change according to the size and resolution (dpi) of the screen.

Also, with a display system, when simultaneously displaying video content from multiple sources on the screen in a juxtaposed or superimposed format, the relation in size between simultaneously displayed images is not displayed correctly, which causes the size and position of the target region of these images to become inconsistent, which then creates an image that is quite visibly poor for the user.

Also, for those terminals equipped with a rotating mechanism, when the screen position is changed, this causes poor visibility for the user, and so display screen has to be rotated.

### SUMMARY

It has been found desirable to provide a superior information processing device, information processing method, and computer program, whereby a large screen is implemented to enable multiple users to share and operate a touch panel so that the users can suitably perform collaborative work.

Also, it has been found desirable to provide a superior information processing device, information processing method, and computer program that provides consistently high quality user-friendliness during user operation, regardless of user position or user state.

Also, it has been found desirable to provide a superior information processing device, information processing method, and computer program that can consistently display object images on the screen at the appropriate size independent of the size of the actual object, or the size and resolution of the image.

Also, it has been found desirable to provide a superior information processing system, information processing method, and computer program that can suitably and simultaneously display video content from multiple sources on the screen in a juxtaposed or superimposed format.

Also, it has been found desirable to provides a superior information processing system, information processing method, and computer program that can optimally adjust the display format of video content regarding some arbitrary rotation angle and transition process when rotating the main unit.

According to an embodiment, an information processing device includes a display unit; an object image obtaining unit configured to obtain images of objects to be displayed on the screen of the display unit; a real-size obtaining unit configured to obtain information related to the real size of the objects to be displayed on the screen of the display unit; and a calculating unit configured to process images of the objects based on the real size of the objects obtained by the real size obtaining unit.

The information processing device may further include a display capability obtaining unit configured to obtain information related to display capability including screen size and resolution of the display unit. Also, the calculating unit may be configured to process so that images of the objects can be displayed in real size on the screen of the display unit, based on real size of the objects obtained by the real size obtaining unit, and display capability acquired by the display capability obtaining unit.

The calculating unit may process images of the multiple objects so that the relation in size of corresponding images of the multiple objects is displayed correctly, when images of multiple objects acquired by the object image obtaining unit are displayed simultaneously on the screen of the display unit.

The information processing device may further include a camera unit; and a real size estimating unit configured to estimate the real size of objects included in the images taken by the camera unit.

The information processing device may further include a camera unit; an image recognition unit configured to recognize user faces included in images taken by the camera unit, and obtains facial data; a distance detecting unit configured to detect the distance to the users; and a real size estimating unit configured to estimate the real size of the user faces, based on the facial data of the users and the distance to the users.

According to an embodiment, an information processing method includes obtaining images of objects to be displayed on the screen; obtaining information relating to the real size of the objects that are to be displayed on the screen; and processing images of the objects, based on the real size of the objects obtained in the obtaining of information relating to the real size.

According to an embodiment, a computer program written in a computer-readable format causes a computer to function as a display unit; an object image obtaining unit configured to obtain images of objects to be displayed on the screen of the display unit; a real size obtaining unit configured to obtain information related to the real size of the objects to be displayed on the screen of the display unit; and a calculating unit configured to process images of the objects, based on the real size of the objects obtained by the real size obtaining unit.

The computer program of the present application is defined as a computer program written in a computer-readable format to realize predetermined processing on a computer. That is to say, by installing the computer program on a computer, cooperative operations will be enabled on the computer, which enables the same functional effect as the information processing device of the present application.

With the technology disclosed in the present specification, a superior information processing system, information processing method, and computer program, can be provided, whereby a screen is implemented to enable multiple users to share and operate a touch panel so that the users can suitably perform collaborative work.

Also, with the technology disclosed in the present specification, a superior information processing device, information processing method, and computer program can be provided, that provide good user-friendliness by optimizing the display GUI and input methods that respond to user position and user state.

Also, with the technology disclosed in the present specification, a superior information processing device, information processing method, and computer program, can be provided, that can consistently display object images on the screen at the appropriate size independent of the size of the actual object, or the size and resolution of the image.

Also, with the technology disclosed in the present specification, a superior information processing device, information processing method, and computer program, can be provided, wherein, when simultaneously displaying video content from multiple sources on the screen in a juxtaposed or superimposed format, can present a screen to the user with good visibility by performing normalization processing on images and arranging the size and position of the target region for the images.

Also, with the technology disclosed in the present specification, can be provided a superior information processing device, information processing method, and computer program, can be provided that can optimally adjust the display format of video content regarding the arbitrary rotation angle and transition process when rotating the main unit.

Other objectives, features, and advantages of the technology disclosed in the present specification will be described in more detail in the embodiments described later and the attached diagrams.

### BRIEF DESCRIPTION OF THE DRAWINGS

FIG. 1 is a diagram illustrating an example use case of an information processing device with a large screen (Wall);

FIG. 2 is a diagram illustrating another example use case of the information processing device with a large screen (Tabletop);

FIG. 3A is a diagram illustrating another example use case of the information processing device with a large screen;

FIG. 3B is a diagram illustrating another example use case of the information processing device with a large screen;

FIG. 3C is a diagram illustrating another example use case of the information processing device with a large screen;

FIG. 4 is a diagram schematically illustrating the functional configuration of the information processing device;

FIG. 5 is a diagram illustrating the internal configuration of an input interface unit;

FIG. 6 is a diagram illustrating the internal configuration of an output interface unit;

FIG. 7 is a diagram illustrating the internal configuration for a calculating unit to perform processing of operable objects;

FIG. 8 is a diagram illustrating a situation in which a user occupied region is set on the screen;

FIG. 9A is a diagram illustrating a situation in which operable objects #1 through #6 are randomly arranged before setting a user occupied region A;

FIG. 9B is a diagram illustrating a situation in which the direction of operable objects #1 through #6 have changed to face the user A by setting the user occupied region A of the user A;

FIG. 10 is a diagram illustrating a situation in which, in addition to user A, the presence of user B is detected, and a user occupied region B for user B and a shared region are set and added to the screen;

FIG. 11 is a diagram illustrating a situation in which, in addition to users A and B, the presence of user D is detected, and a user occupied region D for user D and a shared region are set and added to the screen;

FIG. 12 is a diagram illustrating a situation in which, in addition to users A, B, and D, the presence of user C is detected, and a user occupied region C for user C and a shared region are set and added to the screen;

FIG. 13A is a diagram illustrating an example region dividing pattern in which the user occupied regions are divided for each user on the screen according to the size and format of the screen and number of users;

FIG. 13B is a diagram illustrating an example region dividing pattern in which the user occupied regions are divided for each user on the screen according to the size and format of the screen and number of users;

FIG. 13C is a diagram illustrating an example region dividing pattern in which the user occupied regions are divided for each user on the screen according to the size and format of the screen and number of users;

FIG. 13D is a diagram illustrating an example region dividing pattern in which the user occupied regions are divided for each user on the screen according to the size and format of the screen and number of users;

FIG. 13E is a diagram illustrating an example region dividing pattern in which the user occupied regions are divided for each user on the screen according to the size and format of the screen and number of users;

FIG. 14 is a flowchart illustrating a processing method used by a monitor region dividing unit to execute the monitor region dividing;

FIG. 15 is a diagram illustrating a situation in which operable objects are automatically rotated in the direction of facing the user when moved by dragging or throwing to the user occupied region;

FIG. 16 is a diagram illustrating a situation in which operable objects in a newly created user occupied region are automatically rotated in the direction of the user;

FIG. 17 is a flowchart illustrating an order used by an object optimization processing unit to execute the operable object optimization processing;

FIG. 18 is a diagram illustrating a situation in which the rotation direction is controlled according to the position of where the user has touched the operable object;

FIG. 19 is a diagram illustrating a situation in which the rotation direction is controlled according to the position of where the user has touched the operable object;

FIG. 20 is a diagram illustrating an example interaction of performing transfer of operable objects between the information processing device and a user-owned terminal;

FIG. 21 is a flowchart illustrating a processing order used by a device link data exchanging unit to execute device link data exchanging;

FIG. 22 is a diagram illustrating a situation in which operable objects are moved between user occupied regions, and operable objects are duplicated;

FIG. 23 is a diagram illustrating an internal configuration for the calculating unit to perform optimization processing according to user distance;

FIG. 24A is a diagram containing a table summarizing optimization processing of a GUI display, according to user position obtained by a display GUI optimization unit and user state;

FIG. 24B is a diagram illustrating screen transition of the information processing device, according to user position and user state;

FIG. 24C is a diagram illustrating screen transition of the information processing device, according to user position and user state;

FIG. 24D is a diagram illustrating screen transition of the information processing device, according to user position and user state;

FIG. 24E is a diagram illustrating screen transition of the information processing device, according to user position and user state;

FIG. 25A is a diagram illustrating an example screen display where various operable objects are randomly displayed for auto-zapping;

FIG. 25B is a diagram illustrating an example screen display where the display position and size of multiple operable objects for auto-zapping are changed moment by moment;

FIG. 26 is a diagram illustrating an example screen display where a user is watching TV, but not engaged in operation;

FIG. 27A is a diagram illustrating an example screen display where a user is operating a TV;

FIG. 27B is a diagram illustrating an example screen display where a user is operating a TV;

FIG. 28 is a diagram containing a table summarizing optimization processing of an input method, according to user position and user state obtained by an input method optimization unit;

FIG. 29 is a diagram containing a table summarizing switching processing of a distance detection method, according to user position obtained by a distance detection method switching unit;

FIG. 30 is a diagram for describing the problems with physical display systems according to the related art;

FIG. 31 is a diagram for describing the problems with physical display systems according to the related art;

FIG. 32 is a diagram illustrating an internal configuration for the calculating unit to perform real size display processing on objects, according to monitor capabilities;

FIG. 33 is a diagram illustrating an example when the same object image is displayed in real size on screens of monitors with different specifications;

FIG. 34 is a diagram illustrating an example when the two object images with different real sizes are displayed on the same screen, correctly preserving the corresponding relation in size;

FIG. 35 is a diagram illustrating an example real size display of object images;

FIG. 36 is a diagram illustrating an example where object images displayed in real size are rotated, or orientation is changed;

FIG. 37A is a diagram illustrating a situation in which real size information of photographic subjects is estimated;

FIG. 37B is a diagram illustrating a situation in which real size display processing of operable objects is performed, based on real size information of estimated photographic subjects;

FIG. 38A is a diagram illustrating a situation in which the size and position of faces of users video chatting are inconsistent;

FIG. 38B is a diagram illustrating a situation in which the size and position of faces of users, who are video chatting, become consistent, due to normalization processing among multiple images;

FIG. 39A is a diagram illustrating a situation in which, when displayed on a screen juxtaposed, the figure of a user is not consistent with the size and position of the figure of an instructor;

FIG. 39B is a diagram illustrating a situation in which, when displayed on a screen juxtaposed, the figure of a user is consistent with the size and position of the figure of the instructor, due to normalization processing among multiple images;

FIG. 39C is a diagram illustrating a situation in which the normalized figure of a user is superimposed and displayed over the figure of the instructor, due to normalization processing among multiple images;

FIG. 40A is a diagram illustrating a situation in which a sample image of a product does not lay in the right place with the correct relation in size with the video of a user;

FIG. 40B is a diagram illustrating a situation in which, due to normalization processing among multiple images, a sample image of a product is displayed so that it does lay in the right place with the correct relation in size with the video of a user;

FIG. 41 is a diagram illustrating an internal configuration for the calculating unit to perform normalization processing of images;

FIG. 42 is a diagram illustrating a display format where the entire region of video content is displayed in a way that is not completely seen for some arbitrary rotation angle;

FIG. 43 is a diagram illustrating a display format where the region of interest within video content is maximized for each rotation angle;

FIG. 44 is a diagram illustrating a display format where video content is rotated to eliminate invalid regions;

FIG. 45 is a diagram illustrating the relationship of the zoom ratio of video content regarding the rotation position for each display format illustrated in FIG. 42 through FIG. 44;

FIG. 46 is a flowchart illustrating a processing order used by the calculating unit to control the display format of video content, when rotating the information processing device; and

FIG. 47 is a diagram illustrating an internal configuration for the calculating unit to perform processing to adjust the display format of video content regarding the arbitrary rotation angle and transition process of the main unit of information processing device.

### DETAILED DESCRIPTION OF EMBODIMENTS

The following describes in detail the embodiments of the technology disclosed in the present specification, with reference to the drawings.

### A. System Configuration

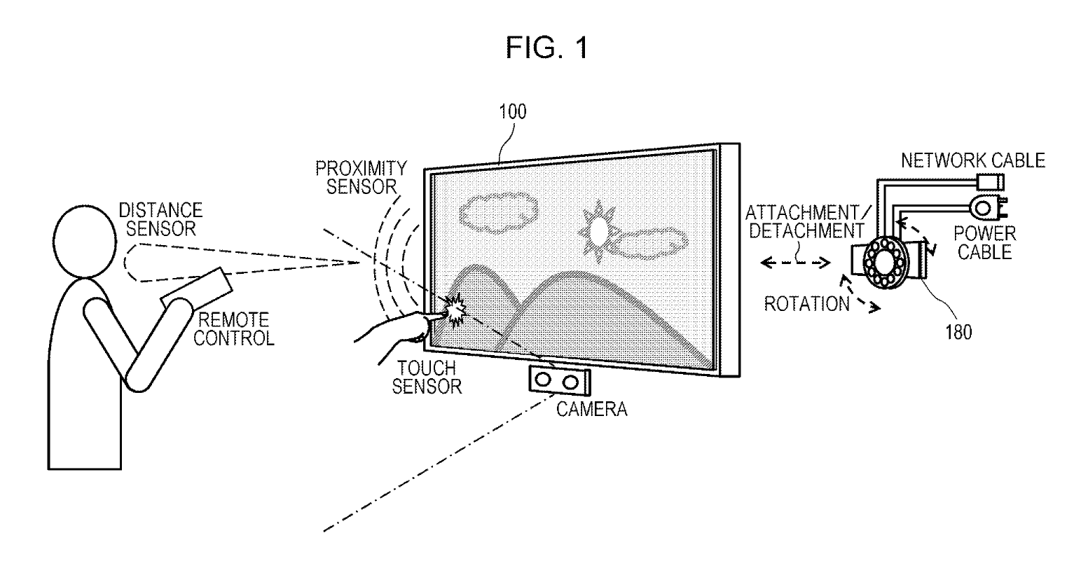

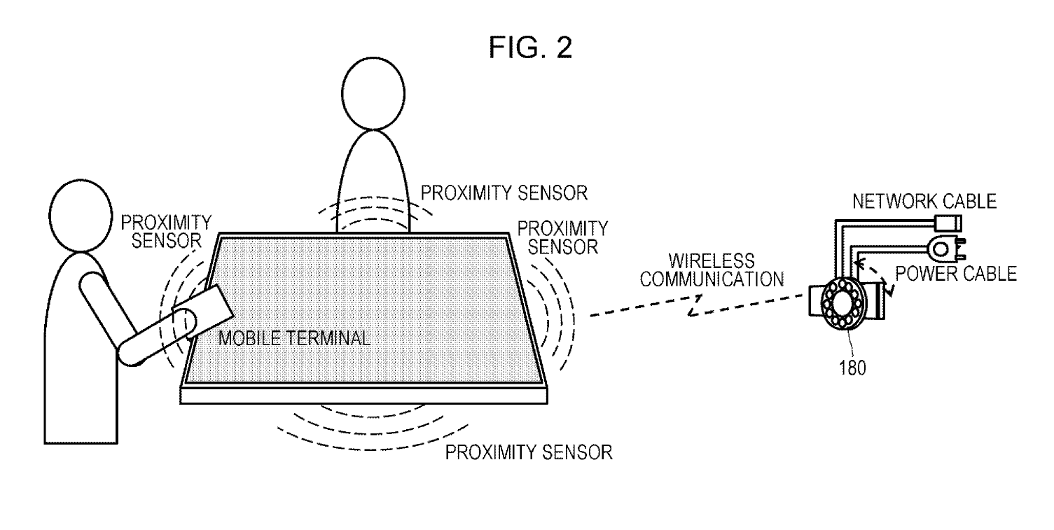

An information processing device 100 according to the present embodiment has a large screen, and is assumed to have, as main use forms, a “Wall” form hanging on a wall as in FIG. 1, or a “Tabletop” form placed on top of a table as in FIG. 2.

In the “Wall” state as shown in FIG. 1, the information processing device 100 is installed in a state that can be rotated and removed from the wall by using, for example, a rotation and installation mechanism unit 180. Also, the rotation and installation mechanism unit 180 combines external electrical connections to the information processing device 100, connecting a power cable and network cable (both not illustrated) to the information processing device 100 via the rotation and installation mechanism unit 180, which allows the information processing device 100 to both receive drive power from a commercial AC power source, and access various servers over the Internet.

As will be described later, the information processing device 100 includes distance sensors, proximity sensors, and touch sensors, and can therefore determine the position of a user facing the screen (distance and direction). When a user is detected, or in a state when a user is being detected, visual feedback is given to the user on screen with a wave pattern detection indicator (described later), or with an illumination graphic that shows the detection state.

The information processing device 100 automatically selects the optimum interaction regarding the position of a user. For example, the information processing device 100 will automatically select and/or adjust the GUI (Graphical User Interface) display, such as the operable object framework, information density, and so forth in accordance with the position of the user. Also, the information processing device 100 automatically selects, according to user position and distance to user, from among multiple input methods, such as gestures involving touches to the screen, proximity, and hands, remote controls, and indirect operations based on user state.

Also, the information processing device 100 includes more than one camera, in which not only the user position, but recognition of people, objects, and devices from images taken by the camera can also be performed. Also, the information processing device 100 includes an extreme close range communication unit, in which direct and natural data exchange can occur with a user-owned terminal in extreme close range proximity.

Operable objects that are the targets of user operation are defined on the large screen of “Wall”. Operable objects have specific display regions for functional modules including moving images, still images, text content, as well as any Internet sites, applications, or widgets. Operable objects include received content from television broadcasts, playable content from recordable media, streaming moving images obtained through a network, moving image and still image contents downloaded from other user-owned terminals such as mobile devices, and others.

As shown in FIG. 1, when the rotation position of the information processing device 100 hanging on the wall is set so that the large screen is horizontal, video, as an operable object as large as the entire screen, can be displayed that presents a perspective close to that of a movie.

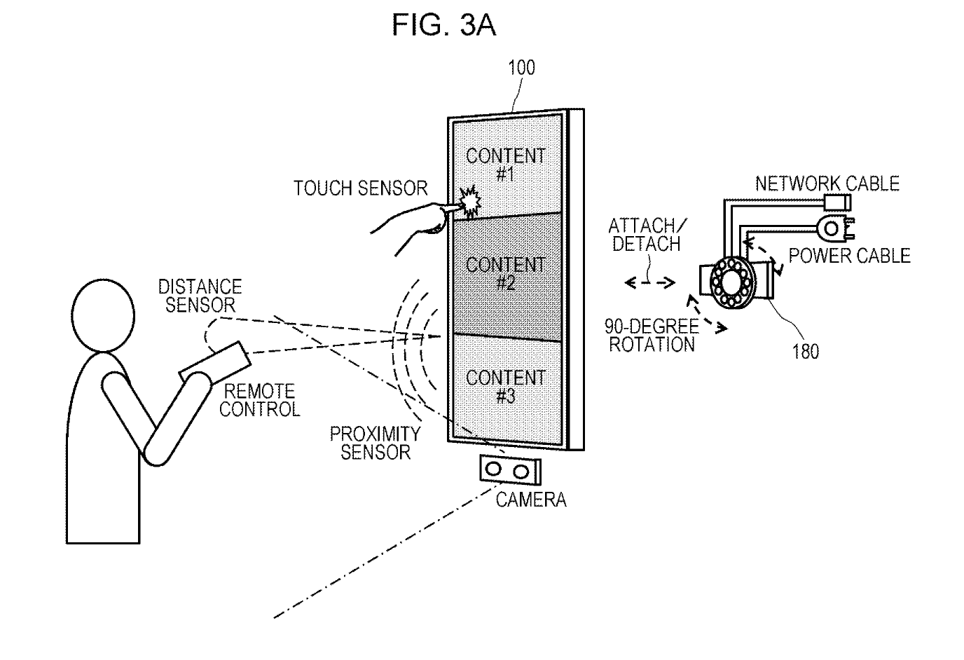

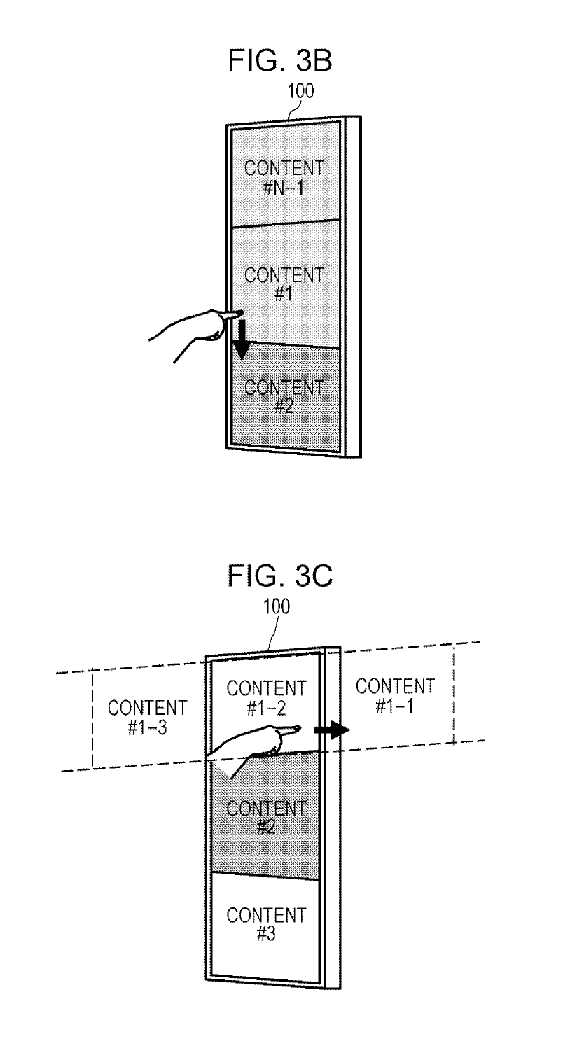

At this point, by setting the rotation position of the information processing device 100 hanging on a wall so that the large screen is vertical, three screens with an aspect ratio of 16:9 can be arranged vertically, as shown in FIG. 3A. For example, three types of contents #1 through #3, such as broadcast content simultaneously received from different broadcast stations, playable content from recordable media, and streaming moving images from a network, can be simultaneously displayed vertically arrayed. Furthermore, a user can operate the screen vertically with a finger, for example, to scroll through the content vertically, as shown in FIG. 3B. Also, a user can operate one of the spots from among the three tiers horizontally with a finger, to horizontally scroll the screen in that tier, as shown in FIG. 3C.

Meanwhile, with the “Tabletop” state as shown in FIG. 2, the information processing device 100 is directly installed on top of a table. In contrast to the use case shown in FIG. 1, in which the rotation and installation mechanism unit 180 provides the electrical connections (described previously), there does not appear to be any electrical connections to the information processing device 100 in the state in which it is installed on top of a table as shown in FIG. 2. For the Tabletop state as shown, the information processing device 100 can be configured to operate without a power source by using an internal battery. Also, by equipping the information processing device 100 with a wireless communication unit corresponding to a wireless LAN (Local Area Network) mobile station function, and by equipping the rotation and installation mechanism unit 180 with a wireless communication unit corresponding to a wireless LAN access point, the information processing device 100 can wirelessly connect with the rotation and installation mechanism unit 180 functioning as the access point to enable access to various servers on the Internet, even when in the Tabletop state.

On the screen of the Tabletop large screen, multiple operable objects that are operation targets are defined. Operable objects have specific display regions for functional modules including moving images, still images, text content, as well as any Internet sites, applications, or widgets.

The information processing device 100 is equipped with proximity sensors to detect user presence and state on each of the four edges of the large screen. As described previously, a user in close proximity to the large screen can be person recognized by shooting with a camera. Also, extreme close range communication unit can detect whether a user, whose presence has been detected, possesses a mobile terminal or other such device, and can also detect data exchange requests from other terminals the user possesses. When a user or terminal possessed by a user is detected, or in a state when a user is being detected, visual feedback is given to the user on screen with a wave pattern detection indicator, or with an illumination graphic that shows the detection state (described later).

When the information processing device 100 detects the presence of a user via a proximity sensor or similar, the detection result is used for UI control. In addition to detecting the presence or non-presence of a user, by also detecting the trunk, arms and legs, position of the head, and so forth, this can be used for more detailed UI control. Also, the information processing device 100 is equipped with extreme close range communication unit, in which direct and natural data exchange can occur with a user-owned terminal in extreme close range proximity (same as above).

Here, as an example of UI control, the information processing device 100 sets a user occupied region for each user and a shared region to be shared among each user on the large screen, according to the detected user arrangement. Touch sensor input is then detected from each user at user occupied regions and the shared region. The screen and pattern used in region division is not limited to a rectangular shape, and can also be applied to other shapes including square, round, and three-dimensional shapes such as cones, and others.

By enlarging the screen of the information processing device 100, enough space is created to enable multiple users to simultaneously perform touch input in the Tabletop state. As described previously, by setting a user occupied region for each user and a shared region on the screen, a more comfortable and efficient simultaneous operation by multiple users can be realized.

Operational rights are given to the appropriate user for operable objects placed in a user occupied region. When a user moves an operable object from the shared region or another user's user occupied region to his/her user occupied region, the operational rights also transfer to that user. Also, when an operable object enters his/her user occupied region, the display of the operable object is automatically changed to directly face that user.

Regarding cases when an operable object is moved to a user occupied region, the operable object is physically moved using a natural operation with regard to the touch position of the movement operation. Also, users can pull the same object toward themselves, which enables an operation to divide or duplicate the operable object.

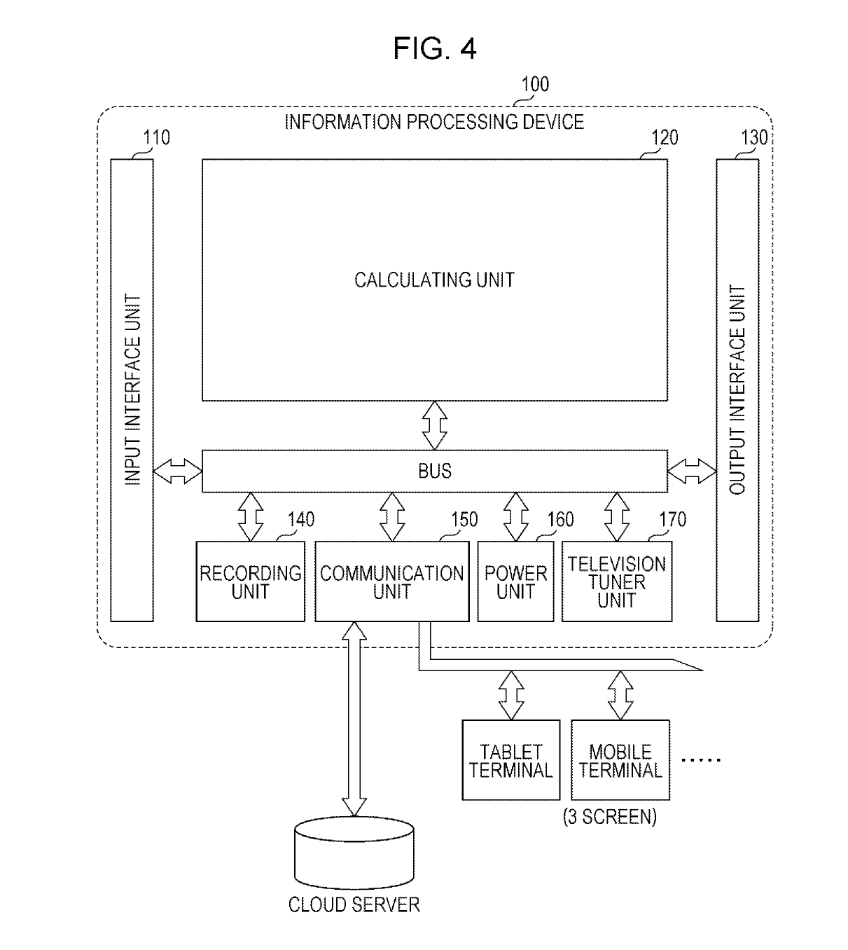

FIG. 4 schematically illustrates the functional configuration of the information processing device 100. The information processing device 100 includes an input interface unit 110, which inputs external information signals; a calculating unit 120, which performs calculating processing to control the display screen, based on the input information signals; an output interface unit 130, which performs external information output, based on the calculating result; a high capacity recording unit 140, configured of a hard disk drive (HDD) or similar; a communication unit 150, which connects with external networks; a power unit 160, which handles drive power; and a television tuner unit 170. The recording unit 140 stores all processing algorithms executed by the calculating unit 120, and all databases used by the calculating unit 120 for calculation processing.

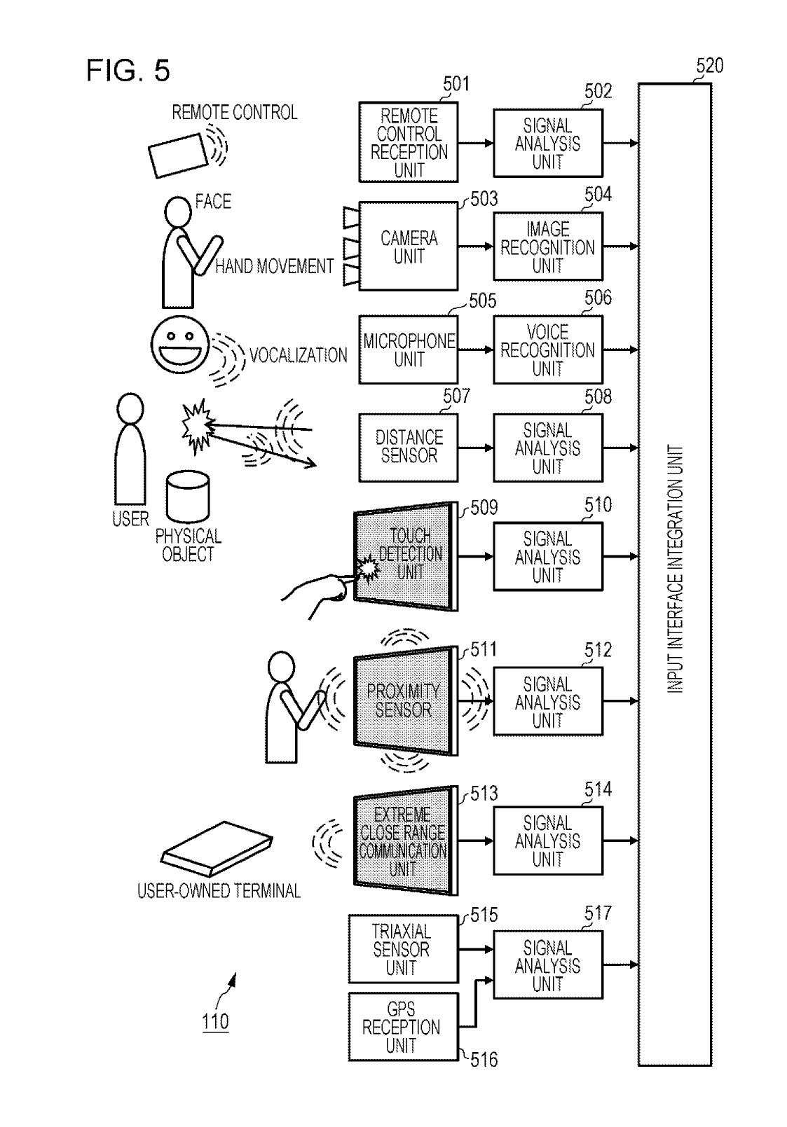

The main functions of the input interface unit 110 include detection of user presence, detection of touch operation of a screen, i.e., a touch panel, by a detected user, detection of user-owned terminals such as a mobile terminal, and reception processing of transmitted data received from such a device. FIG. 5 illustrates the internal configuration of the input interface unit 110.

A remote control reception unit 501 receives remote control signals from a remote control or mobile terminal. A signal analysis unit 502 demodulates received remote control signals, processes decoding, and retrieves the remote control command.

A camera unit 503 implements either one of or both of a single-lens type, or dual-lens type or active autofocus. The camera has an imaging device such as a CMOS (Complementary Metal Oxide Semiconductor) or a CCD (Charge Coupled Device). Also, the camera unit 503 is equipped with a camera control unit enabling pan, tilt, zoom, and other functions. As the camera unit 503 sends camera information such as pan, tilt, zoom, and similar to the calculating unit 120, the camera unit 503 pan, tilt, and zoom is controlled according to the camera control information from the calculating unit 120.

An image recognition unit 504 processes recognition of images taken by the camera unit 503. Specifically, a user's face and hand movement are detected by background differencing, in which gestures are recognized, user faces included in taken images are recognized, people are recognized, and distance to a user is recognized.

A microphone unit 505 inputs voice from dialogue emitted by users and other sounds. A voice recognition unit 506 performs voice recognition on input voice signals.

A distance sensor 507 is configured of a PSD (Position Sensitive Detector) for example, and detects signals reflected from users and other physical objects. A signal analysis unit 508 analyzes these detected signals, and measures the distance to the user or physical object. In addition to a PDS sensor, a pyro electric sensor or basic camera can be used in the distance sensor 507. The distance sensor 507 constantly monitors for user presence within a radius of 5 to 10 meters, for example, from the information processing device 100. For this reason, it is preferable to use a sensing device of low power consumption in the distance sensor 507.

A touch detection unit 509 is configured of a touch sensor superimposed in the screen, and outputs detected signals from the place the user's fingers touched the screen. A signal analysis unit 510 analyzes these detected signals, and obtains position information.

A proximity sensor 511 is arranged at each of the four edges of the large screen, detects when a user's body is near the screen, via the capacitance method, for example. A signal analysis unit 512 analyzes these detected signals.

An extreme close range communication unit 513 receives non-contact communication signals from a user-owned terminal, via NFC (Near Field Communication) for example. A signal analysis unit 514 demodulates these received signals, processes decoding, and obtains received data.

A triaxial sensor unit 515 is configured of a gyro, and detects the orientation of the information processing device 100 around its x, y, and z axes. A GPS (Global Positioning System) reception unit 516 receives signals from a GPS satellite. A signal analysis unit 517 analyzes signals from the triaxial sensor unit 515 and The GPS reception unit 516, and obtains position and orientation information on the information processing device 100.

An input interface integration unit 520 integrates input from the above information signals, and forwards to the calculating unit 120. Also, the input interface integration unit 520 integrates the analysis results from signal analysis units 508, 510, 512, and 514, obtains position information on users near the information processing device 100, and forwards to the calculating unit 120.

The main functions of the calculating unit 120 are calculation processing such as of UI screen generation processing, based on data received from user detection result from the input interface unit 110, screen touch detection result, and user-owned terminals, and output of the calculating result to the output interface unit 130. The calculating unit 120 loads the application program installed in the recording unit 140, for example, and can enable the calculating processing through the execution of each application. The functional configuration of the calculating unit 120 corresponding to each application will be described later.

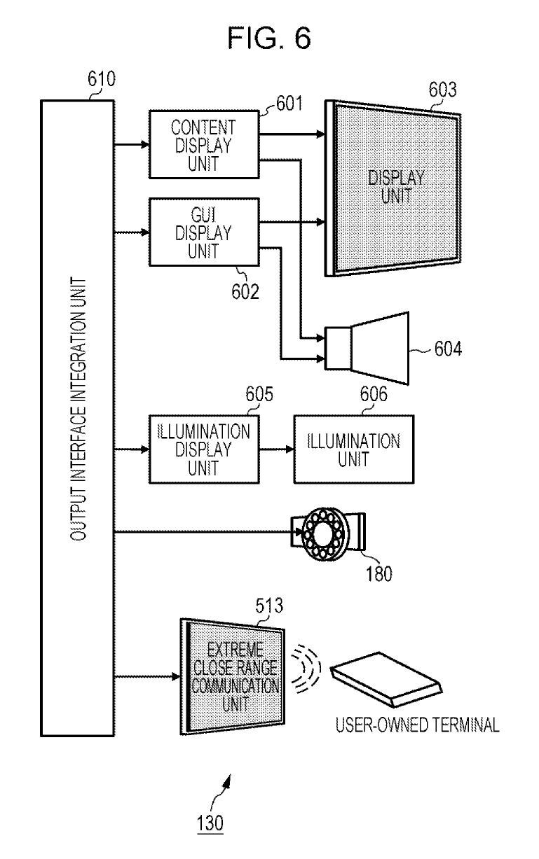

The main functions of the output interface unit 130 are UI display to the screen, based on the calculating result of the calculating unit 120, and sending of data to user-owned terminals. FIG. 6 illustrates the internal configuration of the output interface unit 130.

An output interface integration unit 610 handles the integration of information output, based on the calculating result for monitor dividing processing, object optimization processing, and device link data exchanging processing, and others by the calculating unit 120.

Output interface integration unit 610 directs a content display unit 601 regarding image and voice output to a display unit 603, for moving image and still image content, and to a speaker unit 604, with regard to received television broadcast content, playable content from recordable media such as a Blu-ray disc, and so forth.

Also, the output interface integration unit 610 directs a GUI display unit 602 regarding display of operable objects and the like at the GUI display unit 603.

Also, the output interface integration unit 610 directs display output of illumination representing detection state from an illumination unit 606 to an illumination display unit 605.

Also, the output interface integration unit 610 directs the extreme close range communication unit 513 regarding sending of non-touch communication data to user-owned terminals and so forth.

The information processing device 100 can detect users, based on detected signals from recognition of images taken by the camera unit 503, the distance sensor 507, the touch detection unit 509, the proximity sensor 511, the extreme close range communication unit 513, and others. Also, by recognizing user-owned terminals via recognition of images taken by the camera unit 503 and the extreme close range communication unit 513, people, which were detected as users, can be specified. Of course, this can be limited to specifying only users with accounts that can be logged into. Also, the information processing device 100 can accept operation from users by incorporating the distance sensor 507, the touch detection unit 509, and the proximity sensor 511, according to user position and user state.

Also, the information processing device 100 connects to external networks through the communication unit 150. External network connection format can be either wired or wireless. The information processing device 100 can also communicate with, through the communication unit 150, other devices such as tablet terminals and mobile terminals, such as user-owned smartphones. A “3-screen” configuration can be made using the 3 types of devices, namely the information processing device 100, mobile terminals, and tablet terminals. The information processing device 100 can supply a UI that links three screens, on the large screen, from the other two screens.

For example, in the background of an action being performed in which a user performs a touch operation of the screen, or an owned terminal is brought into proximity with the information processing device 100, data exchange of moving images, still images, and text content, which make up the entity of operable objects, is performed between the information processing device 100 and the corresponding owned device. Furthermore, cloud servers can be established on an external network, the 3 screens can use the calculating capability of the cloud server, or some similar function, in which the benefit of cloud computing can be received through the information processing device 100.

The following describes, in order, several applications of the information processing device 100.

B. Simultaneous Operation from Multiple Users on the Large Screen

Simultaneous operation from multiple users on the large screen can be made with the information processing device 100. Specifically, it is equipped with proximity sensors 511 to detect user presence and state, at each of the four edges of the large screen, and by setting user occupied regions and a shared region on the screen according to the user arrangement, comfortable and efficient simultaneous operation by multiple users can be realized.

By enlarging the screen of the information processing device 100, enough space is created to enable multiple users to simultaneously perform touch input in the Tabletop state. As described previously, by setting a user occupied region for each user and a shared region on the screen, a more comfortable and efficient simultaneous operation by multiple users can be realized.

Operational rights are given to the appropriate user for operable objects placed in a user occupied region. When a user moves an operable object from the shared region or another user's user occupied region to his/her user occupied region, the operational rights also transfer to that user. Also, when an operable object enters his/her user occupied region, the display of the operable object is automatically changed to directly face that user.

Regarding cases when an operable object is moved to a user occupied region, the operable object is physically moved using a natural operation with regard to the touch position of the movement operation. Also, users can pull the same operable object toward themselves, which enables an operation to divide or duplicate the operable object.

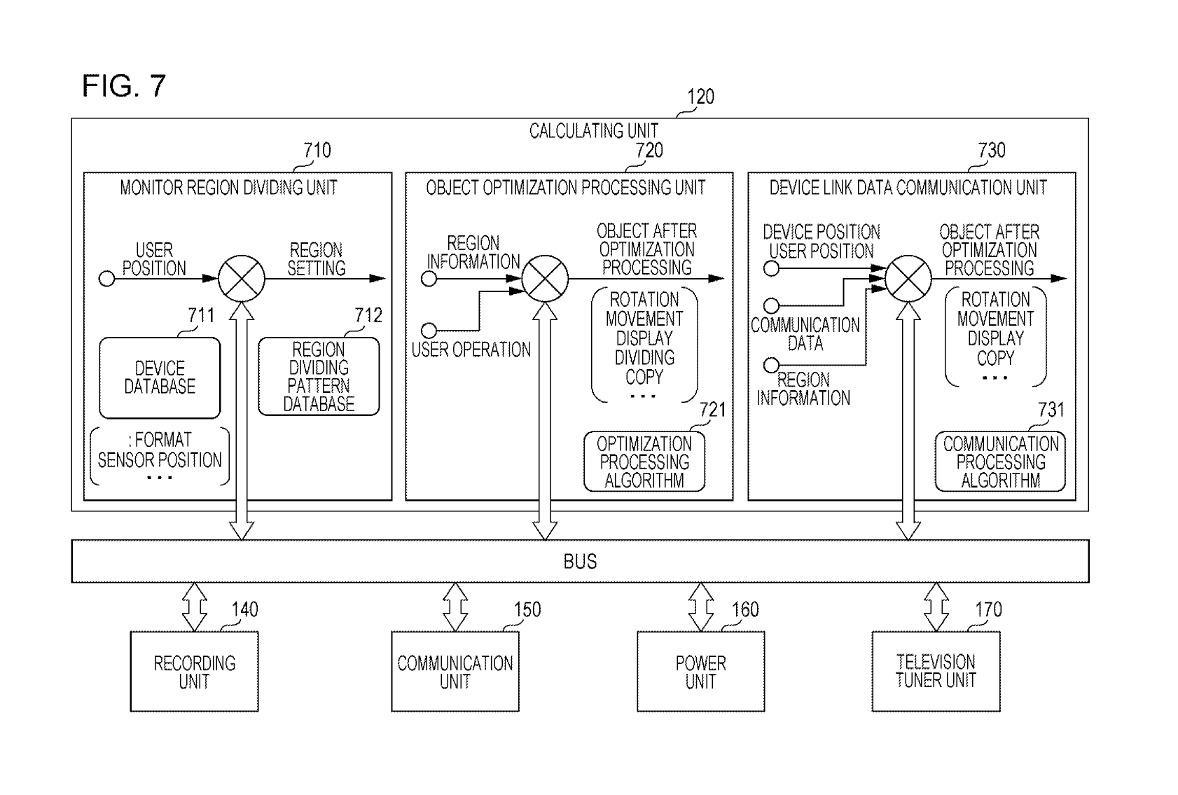

The main function of the calculating unit 120 when executing this application is generating UI and optimizing operable objects, based on data received by user-owned terminals, screen touch detection results, and user detection results from the input interface unit 110. FIG. 7 illustrates an internal configuration for processing performed on operable objects by the calculating unit 120. The calculating unit 120 is equipped with a monitor region dividing unit 710, an object optimization processing unit 720, and a device link data exchange processing unit 630.

The monitor region dividing unit 710 obtains user position information from the input interface integration unit 520, references a region pattern database 712 and a device database 711 related to formats and sensor arrangement, which are stored in the recording unit 140, in order to set the previously described user occupied regions and shared region on the screen. Also, the monitor region dividing unit 710 forwards the configured region information to the object optimization processing unit 720 and a device link data exchange unit 730. Details of the processing method for monitor region dividing will be described later.

The object optimization processing unit 720 inputs information on operations performed by the user on operable objects on the screen from the input interface integration unit 520. Also, the object optimization processing unit 720 performs optimization processing on operable objects, which are operated on by a user, such as rotation, movement, display, division, and copying of operable objects operated by a user, according to an optimization processing algorithm 721 loaded from the recording unit 140, and outputs the operable objects, which have received optimization processing, to the screen of the display unit 603. Details on operable object optimization processing will be described later.

The device link data exchange unit 730 inputs exchanged data of the device from the input interface integration unit 520, regarding position information on users and user-owned terminals. Also, the device link data exchange unit 730 performs data exchange processing by linking to user-owned terminals, according to an exchange processing algorithm 731 loaded from the recording unit 140. Also, optimization processing is performed on corresponding operable objects. Details on operable object optimization processing will be described later. Optimization processing, related to exchanged data, is performed on operable objects, such as rotation, movement, display, division, and copying of operable objects regarding data exchange with user-owned terminals that are linked, and outputs the operable objects, which have received optimization processing, to the screen of the display unit 603. Details on operable object optimization processing with regards to linked devices will be described later.

Next, details on monitor region dividing processing will be described. Monitor region dividing is expected to mainly be used in processing the use case in which multiple users are sharing the information processing device 100 in the Tabletop state, but of course this can be applied to the use case in which multiple users are sharing in the Wall state as well.

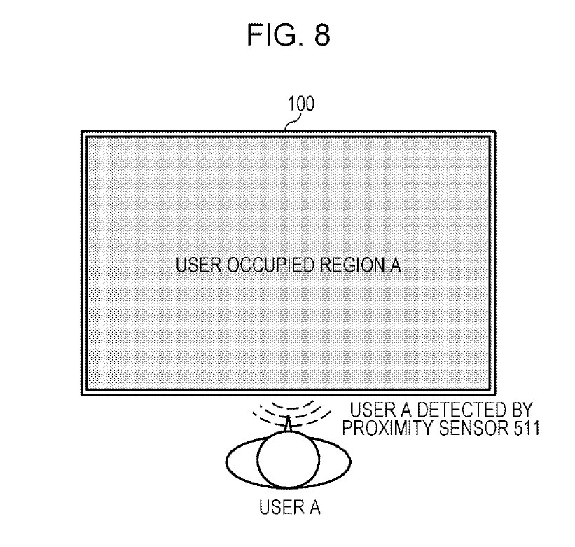

The monitor region dividing unit 710 allocates user occupied regions on the screen to users when the presence of users is detected by the input interface integration unit 520. FIG. 8 illustrates a situation in which user occupied region A is set on the screen for user A by the monitor region dividing unit 710, in response to the detection of the presence of user A by detection signals received from the proximity sensor 511 (or the distance sensor 507) installed in the edge of the screen. In the case that only one user's presence is detected, the entire screen may be set as the user's user occupied region, as illustrated.

Here, after setting user occupied region A, the object optimization processing unit 720 will change the direction of each operable object in user occupied region A to face the user, based on position information of user A obtained through the input interface integration unit 520.

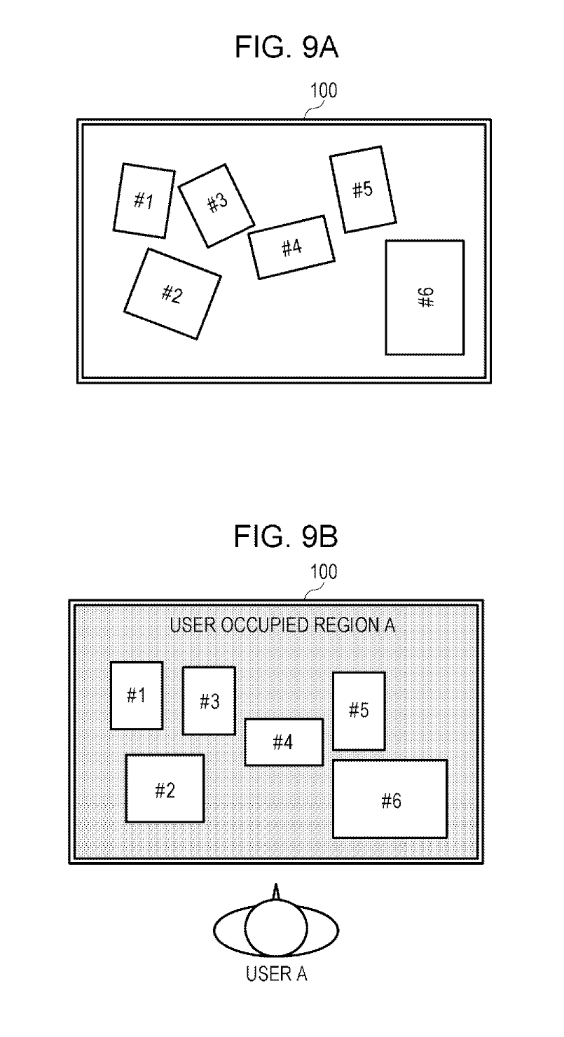

FIG. 9A illustrates a situation in which operable objects #1 through #6 are in random directions before being set to user occupied region A. Also, FIG. 9B illustrates a situation in which the direction of all operable objects #1 through #6 in this region have been changed to face the user A after user occupied region A has been set for user A.

In the case that only the presence of user A has been detected, user occupied region A can be set to the entire screen for user A. In contrast, when the presence of two or more users is detected, it is preferable for a shared region to be set that users can share, in order to perform collaborative work among the users.

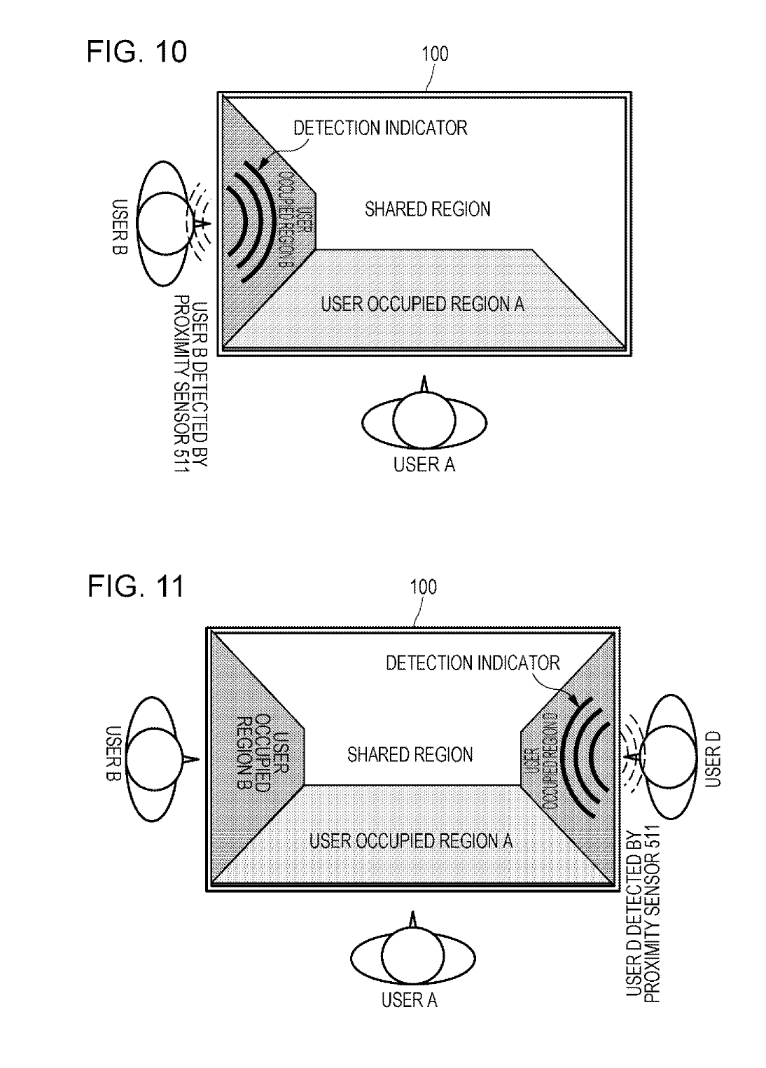

FIG. 10 illustrates a situation in which, in addition to user A, the presence of user B is detected at the adjoining edge of the screen by detection signals from the proximity sensor 511 or the distance sensor 507, which causes the monitor region dividing unit 710 to set and add user occupied region B for user B and a shared region on the screen. Based on position information for user A and B, user A's user occupied region A degenerates toward the place user A is in while user B's user occupied region B is generated near the place user B is in. Also, with the newly detected presence of user B, wave pattern detection indicator is displayed in user occupied region B. After user occupied region B is newly set following user B approaching the information processing device 100, user occupied region B may be enabled the moment after the first arbitrary operable object is touched within user occupied region B. Furthermore, though omitted from FIG. 10, the direction of each operable object in the region that has become the new occupied region B can be changed to face the user the moment user occupied region B is set, or the moment user occupied region B is enabled.

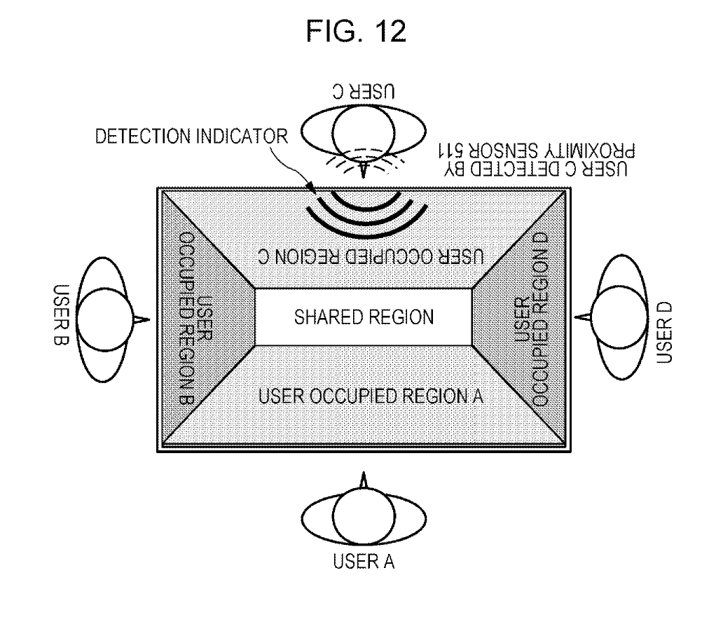

FIG. 11 illustrates a situation in which, in addition to users A and B, the presence of user D is detected at a different edge of the screen, which causes the monitor region dividing unit 710 to set and add user occupied region D for user D on the screen near the place user D is in. The wave pattern detection indicator is displayed in user occupied region D, which represents that the presence of user D has been newly detected. Also, FIG. 12 illustrates a situation in which, in addition to users A, B, and D, the presence of user C is detected at a different edge of the screen, which causes the monitor region dividing unit 710 to set and add user occupied region C for user C on the screen near the place user C is in. The wave pattern detection indicator is displayed in user occupied region C, which represents that the presence of user C has been newly detected.

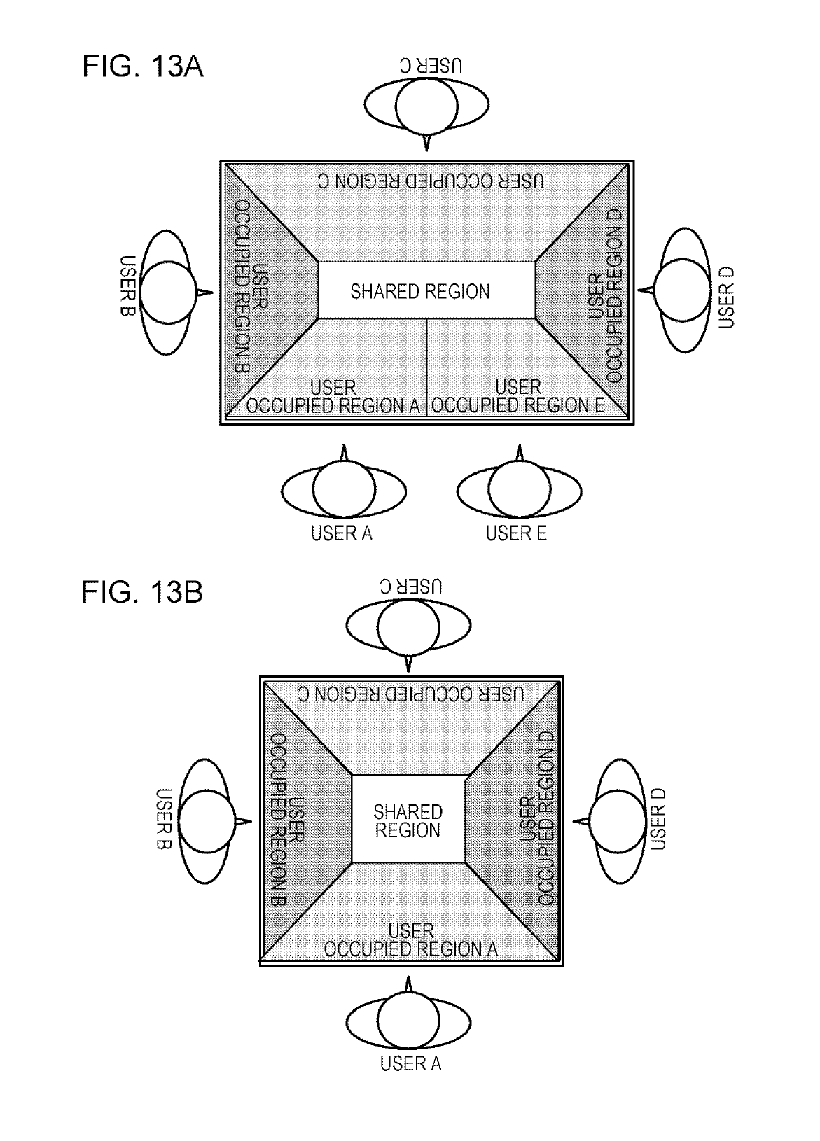

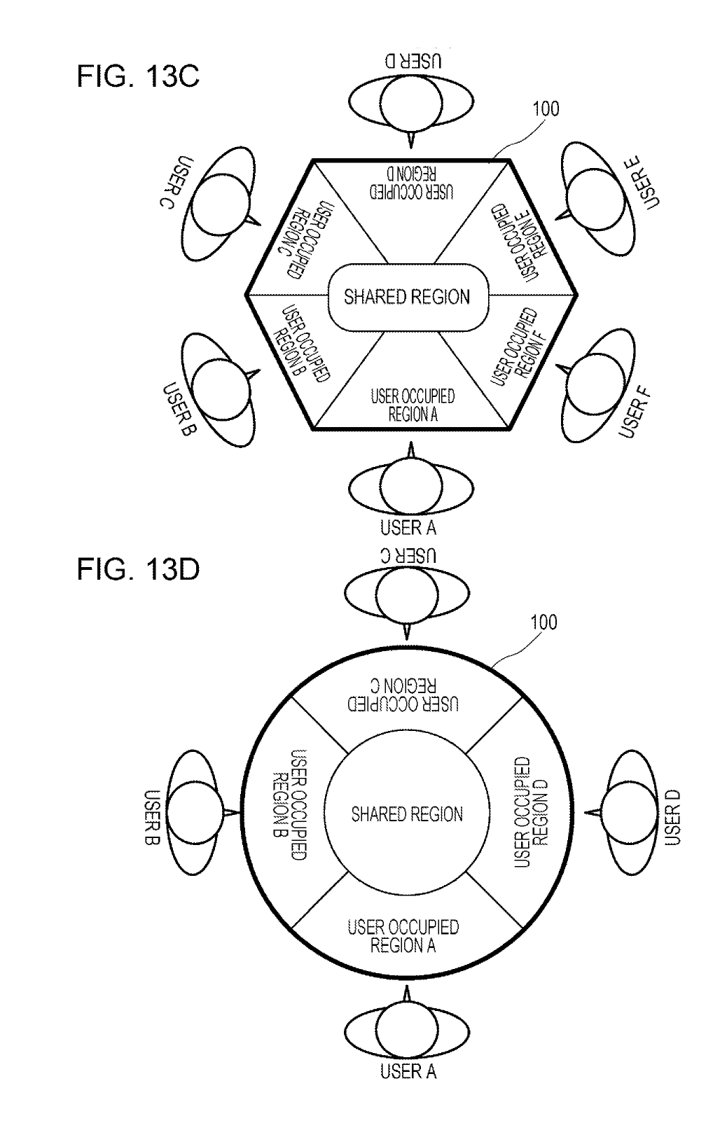

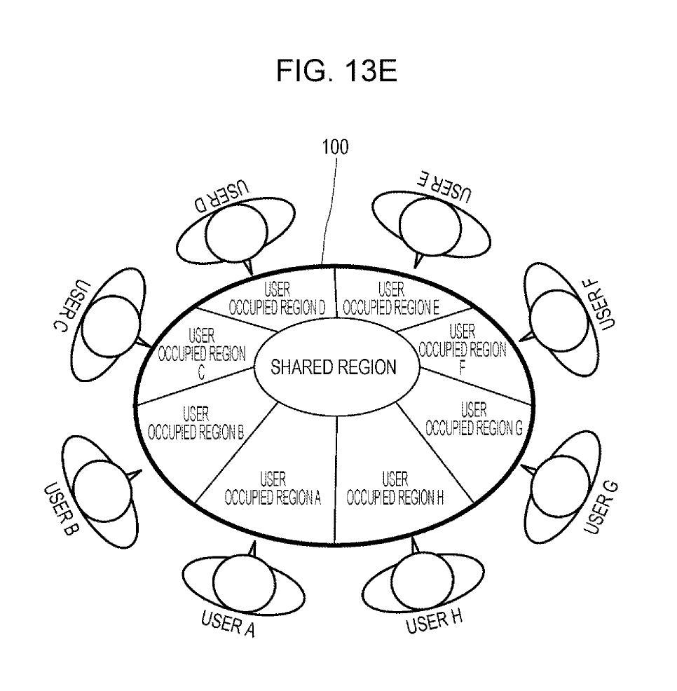

Furthermore, the region dividing pattern for the user occupied regions and shared region illustrated in FIG. 8 through FIG. 12 are only an example. The region dividing pattern depends on the format of the screen, the number of users whose presence is detected, and his/her arrangement, and such. Information related to region dividing patterns, based on screen format, size, and number of users, is accumulated in a region dividing pattern database 611. Also, information on the format and size of the screen used by the information processing device 100 is accumulated in a device database 612. The monitor region dividing unit 710 inputs user position information detected through the input interface integration unit 520, which causes the screen format and size to be read from the device database 612, and the appropriate region dividing pattern is queried from the region dividing pattern database 611. FIG. 13A through FIG. 13E illustrate examples of region dividing patterns in which user occupied regions are divided for each user on the screen, according to screen size and format, and number of users.

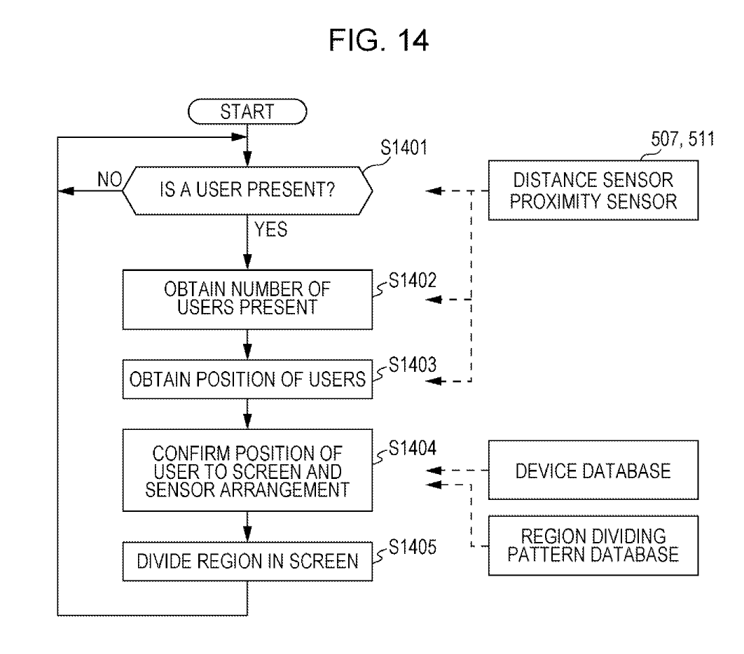

FIG. 14 is a flowchart illustrating the processing method for monitor region dividing executed by the monitor region dividing unit 710.

First, the monitor region dividing unit 710 checks whether a user is present near the screen, based on a signal analysis result from detection signals from the proximity sensor 511 or the distance sensor 507 (step S1401).

When the presence of a user is detected (Yes from step S1401), the monitor region dividing unit 710 will continue by obtaining the numbers of users whose presence is detected (step S1402), and also obtains the position of each user (step S1403). Processing of steps S1401 through S1403 is performed based on user position information passed from the input interface integration unit 520.

Next, the monitor region dividing unit 710 queries device database 511, and obtains device information on arrangement from the proximity sensor 511, and the screen format of the display unit 603 used by the information processing device 100. In conjunction with user position information, it then queries the region dividing pattern database 712 for the appropriate region dividing pattern (step S1404).

Next, the monitor region dividing unit 710 sets each user's user occupied region and the shared region on the screen according to the obtained region dividing pattern (step S1405), and this processing routine ends.

Next, details on object optimization processing by the object optimization processing unit 720 will be described.

The object optimization processing unit 720 inputs operation information performed on operable objects on the screen by the user, through the input interface integration unit 520, and then performs display processing for rotation, movement, display, division, and copying, and such on operable objects on the screen, according to user operation.

Processing of rotation, movement, display, division, and copying of operable objects according to user operations such as dragging and throwing is similar to GUI operation on the screen of a computer desktop.

In the present embodiment, user occupied regions and the shared region have been set on the screen, the object optimization processing unit 720 optimally processes this display based on the region where the operable objects exist. The typical example of optimization processing is the processing to change the direction of operable objects in a user occupied region to face that user.

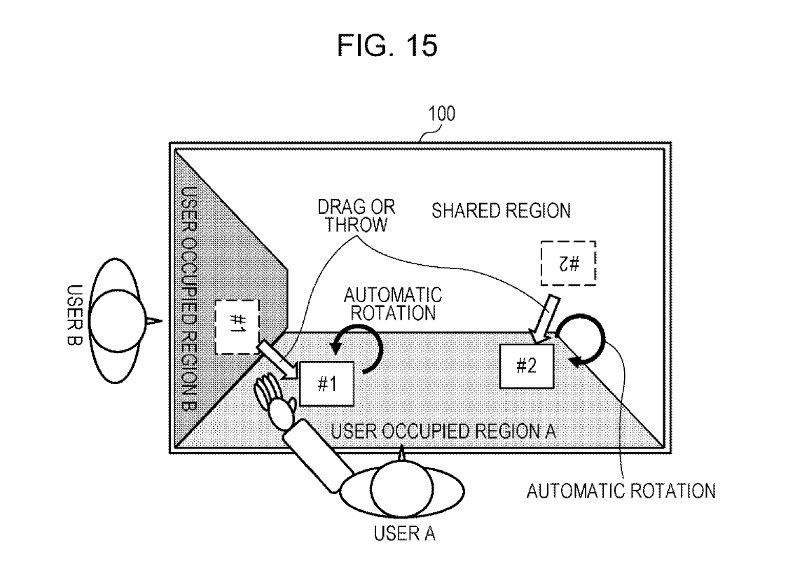

FIG. 15 illustrates a situation in which an operable object #1 is moved by dragging or throwing from the shared region to user A's user occupied region A, and at the moment part of the object or the central coordinate enters the user occupied region A, the object optimization processing unit 720 automatically processes rotation on the object to face user A. Also, FIG. 15 illustrates a situation in which an operable object #2 is moved by dragging or throwing from the user B's user occupied region B to user A's user occupied region A, and at the moment part of the object or the central coordinate enters the user occupied region A, the object optimization processing unit 720 automatically processes rotation on the object to face user A.

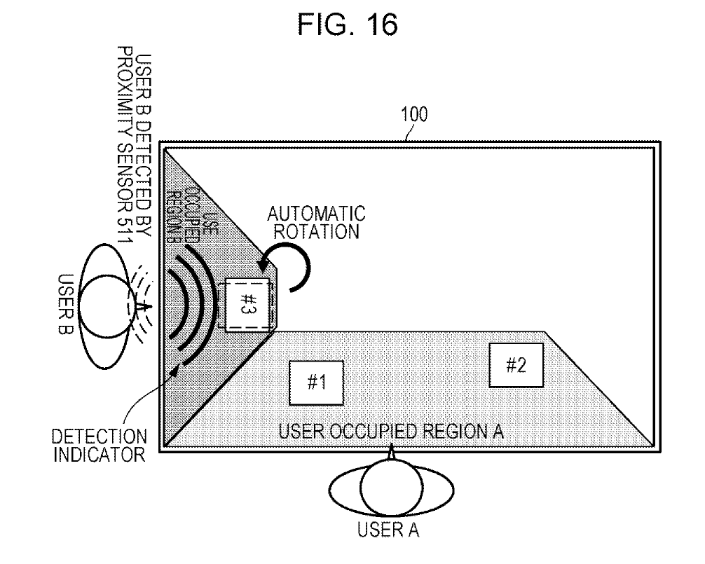

As shown in FIG. 10, when user B is near the information processing device 100, user occupied region B is newly set on the screen near user B. In the case that within this user occupied region B, operable object #3 that was originally facing user A, after user occupied region B is newly generated, the object optimization processing unit 720 immediately automatically performs rotation processing on operable object #3 to face user B, as shown in FIG. 16.

Alternatively, instead of immediately processing rotation on the operable object, after user occupied region B is newly created following user B approaching the information processing device 100, user occupied region B may be enabled the moment after the first arbitrary operable object is touched within user occupied region B. In this case, the moment user occupied region B becomes enabled, simultaneous processing of rotation may occur on all operable objects in user occupied region B to face user B.

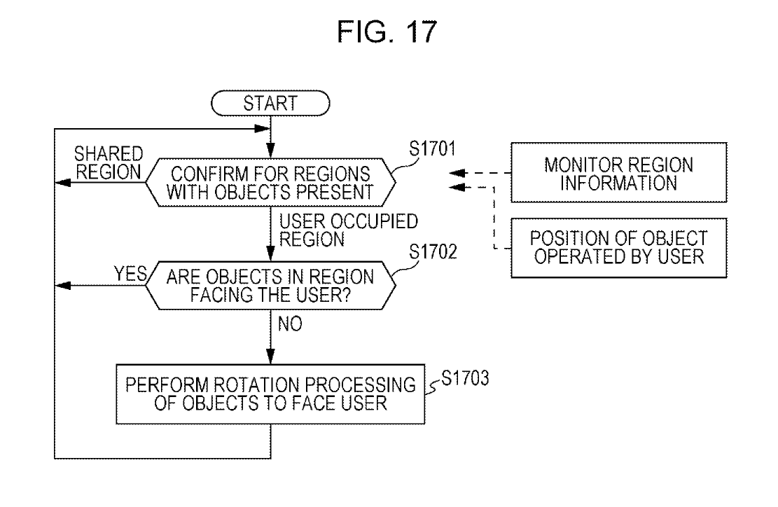

The object optimization processing unit 720 can perform optimization processing on operable objects, based on region information passed from the monitor region dividing unit 710 and user operation information obtained through the input interface integration unit 520. FIG. 17 is a flowchart illustrating the optimization processing method for operable objects executed by the object optimization processing unit 720.

The object optimization processing unit 720 is passed position information on operable objects operated by a user from the input interface integration unit 520 while also obtaining monitor region information divided from the monitor region dividing unit 710, which allows confirmation of in which region the operable object the user operated is (step S1701).

Here, when the operable object operated by the user is in the user occupied region, the object optimization processing unit 720 checks whether this operable object is facing the user in the appropriate user occupied region (step S1702).

Also, when the operable object is not facing the direction of the user (No in step S1702), the object optimization processing unit 720 processes the rotation of the operable object to face the user in the appropriate user occupied region (step S1703).

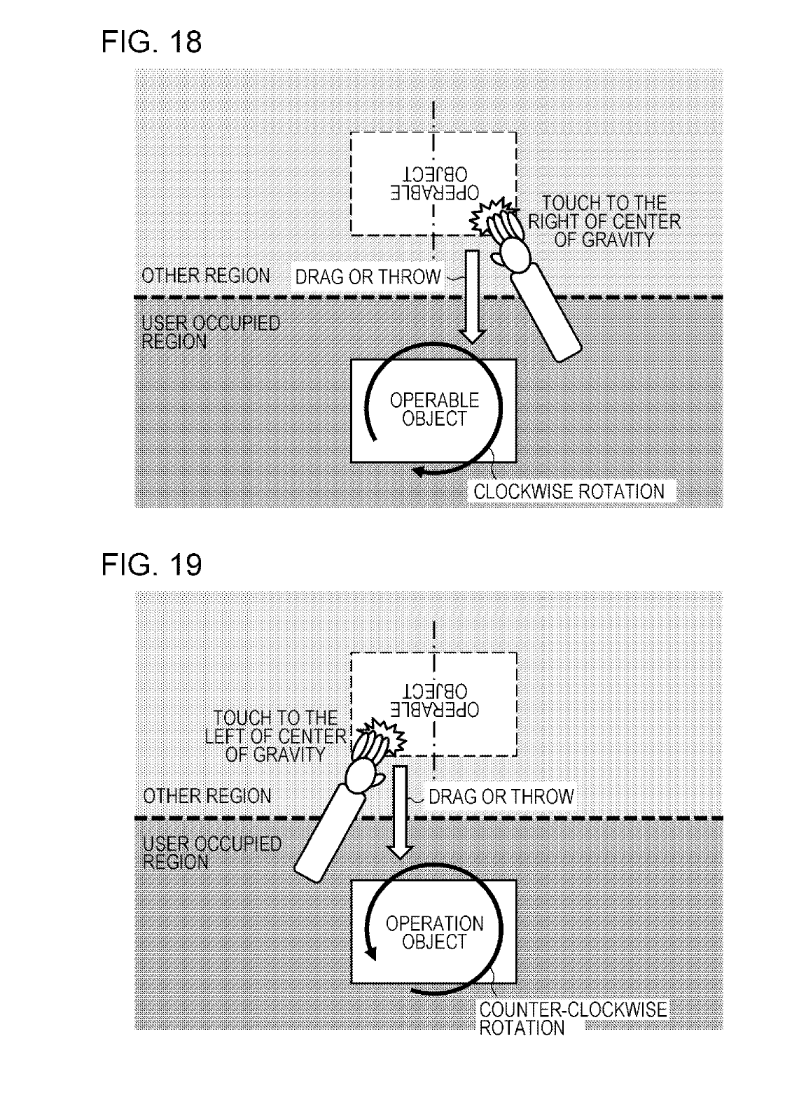

When a user moves, by dragging or throwing, an operable object from the shared region or another user's user occupied region to his/her user occupied region, control of the rotation direction may be allowed, according to the position with which the user operated the operable object by touch. FIG. 18 illustrates a situation in which a user touches and moves, by dragging or throwing, an operable object from its center to the right, and the moment the operable object enters the user occupied region, it is rotated clockwise centrally from its center in a direction to face the user. FIG. 19 illustrates a situation in which a user touches and moves, by dragging or throwing, an operable object from its center to the left, and the moment the operable object enters the user occupied region, it is rotated counter-clockwise centrally from its center in a direction to face the user.

As shown in FIG. 18 and FIG. 19, by switching the rotational direction of operable objects with reference to the center, a feeling of natural operation can be provided to the user.

Next, details on device link data exchange processing by the device link data exchange unit 730 will be described.

As shown in FIG. 4, the information processing device 100 can communicate with other devices such as user-owned mobile terminals through the communication unit 150. For example, in the background of an action being performed in which a user performs a touch operation of the screen, or an owned terminal is brought into proximity with the information processing device 100, data exchange of moving images, still images, and text content, which make up the entity of operable objects, is performed between the information processing device 100 and the corresponding owned device.

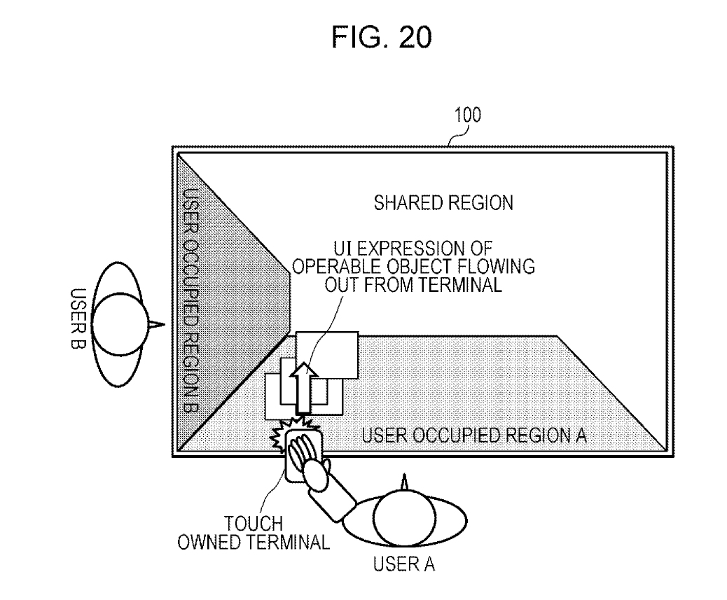

FIG. 20 is a illustrates an example interaction of performing transfer of operable objects between the information processing device 100 and user's own terminal. In the illustrated example, user A brings his/her user-owned terminal to the space close to user occupied region A, which is provisioned thereto, and this causes operable objects to be generated from vicinity of the terminal, and a UI graphic to bring them into user occupied region A.

The information processing device 100 can detect when a user-owned terminal approaches the vicinity of user occupied region A, based on signal analysis results of detected signals by the extreme close range communication unit 513, and recognition results of images taken of the user by the camera unit 503. Also, the device link data exchange unit 730 may be allowed to specify if the user has data to send to the information processing device 100, and what kind of transmission data it is, through the context between user A and the information processing device 100 up to this point (or interactions between user A and other users through the information processing device 100). Also, when there is transmission data, in the background of an action being performed where an owned terminal is brought into proximity with the information processing device 100, the device link data exchange unit 730 can execute the data exchange of moving images, still images, and text content, which make up the entity of operable objects.

While the device link data exchange unit 730 performs data exchange with a user-owned terminal in the background, UI graphics are drawn to generate the operable objects form the user-owned terminal on the screen of the display unit 603, with object optimization processing by the object optimization processing unit 720. FIG. 20 illustrates an example UI graphic where operable objects are brought into the appropriate user occupied region from the terminal.

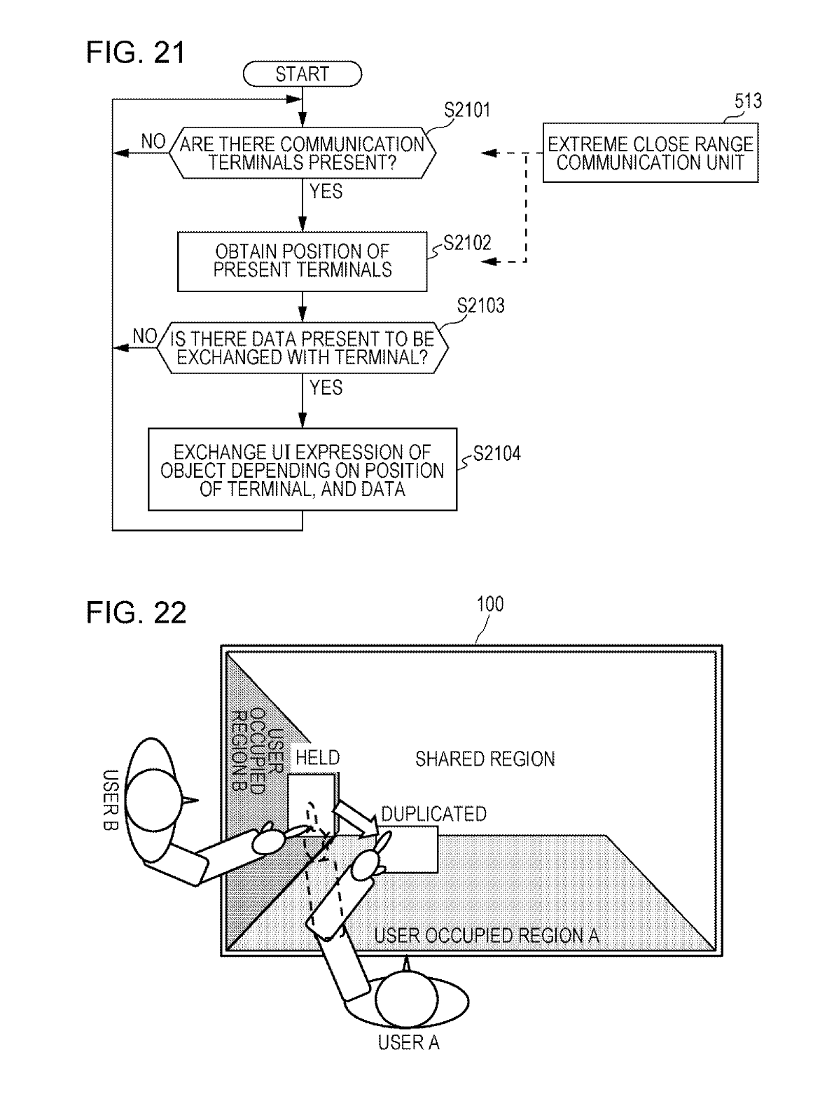

FIG. 21 is a flowchart illustrating a processing order used by the device link data exchange unit 730 to execute device link data exchange. Processing by the device link data exchange unit 730 is started when a user-owned terminal approaches near user occupied region A, based on signal analysis results of detected signals by the extreme close range communication unit 513.

The device link data exchange unit 730 checks for the presence of a communicating user-owned terminal, based on signal analysis results of detected signals by the extreme close range communication unit 513 (step S2102).

When a communicating user-owned terminal is present (Yes in step 2101), the device link data exchange unit 730 obtains the position of the present terminal, based on signal analysis results of detected signals by the extreme close range communication unit 513.

Next, the device link data exchange unit 730 checks whether there is any data to be exchanged with this user-owned terminal (step S2103).

When exchanging data with the user-owned terminal (Yes in step S2103), the device link data exchange unit 730 draws UI graphics for operable objects according to the position of the terminal, according to communication processing algorithm 731 (Refer to FIG. 20). Also, the device link data exchange unit 730 performs data exchange, which makes up the entity of operable objects, with the terminal in the background of the UI display (step S2104).

As shown in FIG. 20 and FIG. 21, operable objects obtained from user-owned terminals by the information processing device 100 are arranged into the appropriate user's user occupied region. Furthermore, when data is exchanged among users, operations can be performed to move operable objects between corresponding user occupied regions. FIG. 22 illustrates a situation in which operable objects retained by user B in user occupied region B are duplicated into user A's user occupied region A. Alternatively, operable objects can be divided instead of duplicated.

Operable objects which have been duplicated on the screen are simply created as independent separate data, in the case of moving image and still image content. Also, in the event that the duplicated operable object is an application window, a separate window will be created to enable the application for collaborative work between the user originally retaining the operable object, and the user to which will be duplicated.

### C. Optimal Selection of Input Method and Display GUI According to User Position

The information processing device 100 includes the distance sensor 507 and the proximity sensor 511, and as illustrated in FIG. 1 and FIGS. 3A and 3B for example, when used hung on a wall, distance from the main unit of the information processing device 100, i.e. the screen, to the user can be detected.

Also, the information processing device 100 includes the touch detection unit 509, the proximity sensor 511, the camera unit 503, and the remote control reception unit 501, and can provide the user with multiple input methods such as gestures using screen touching, proximity, hands and so forth, remote control, and other indirect operation based on user state. The applicability for operation of each input method depends on the distance from the main unit of the information processing device 100, i.e. the screen, to the user. For example, if a user is within a range of 50 cm from the main unit of the information processing device 100, operable objects can certainly be operated by direct touch of the screen. Also, if a user is within a range of 2 m from the main unit of the information processing device 100, they are too far to directly touch the screen, but gesture input can be made due to ability to accurately capture face and hand movement via recognition processing of images taken by the camera unit 503. Also, if a user is separated from the main unit of the information processing device 100 by more than 2 m, the accuracy of image recognition decreases, but remote control operation still can be made as remote control signals will reliably reach. Furthermore, optimal GUI display of information density and framework of operable objects to be displayed on the screen is also changed according to the distance to the user.

According to the present embodiment, the information processing device 100 automatically selects from among multiple input methods according to user position or the distance to the user, while also automatically selecting and adjusting the GUI display according to user position, in order to improve user convenience.

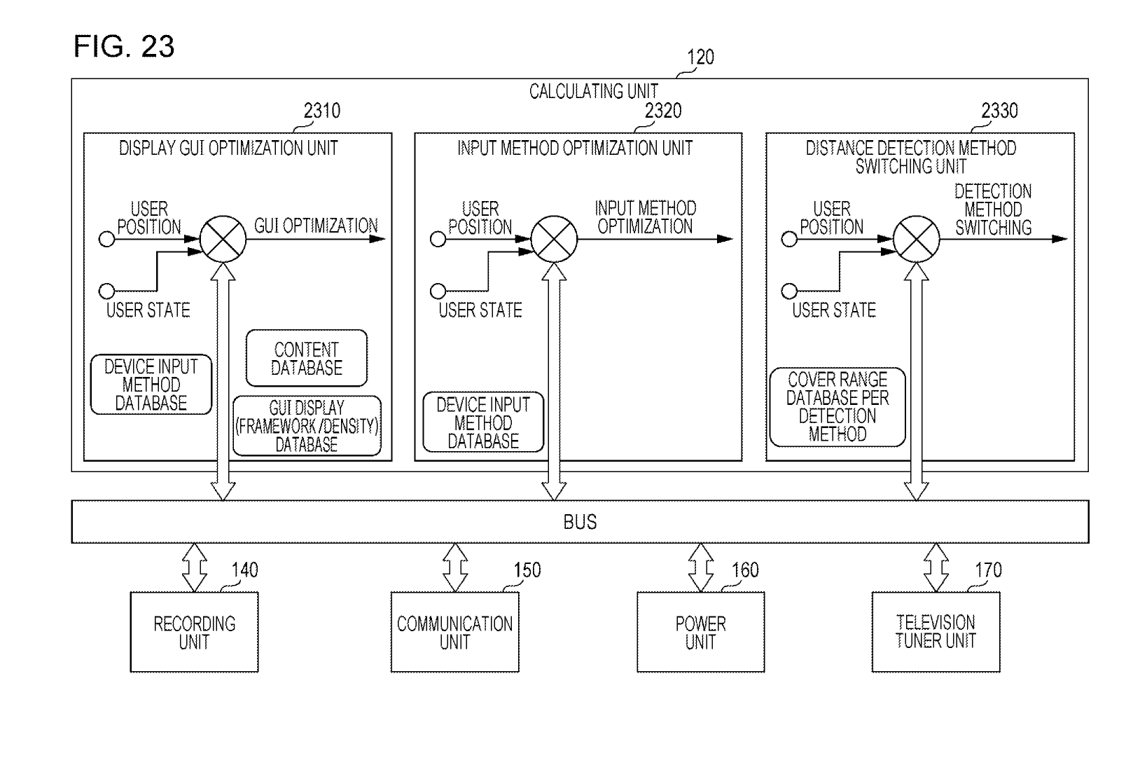

FIG. 23 illustrates an internal configuration for the calculating unit 120 to perform optimization processing according to user distance. The calculating unit 120 is equipped with a display GUI optimization unit 2310, an input method optimization unit 2320, and a distance detection method switching unit 2330.

The display GUI optimization unit 2310 performs optimization processing to create an optimal GUI display of such as information density and framework of operable objects to be displayed on the screen of the display unit 603, according to user position and user state.

Here, user position is obtained by the distance detection method, which is switched by the distance detection method switching unit 2330. As the user position becomes closer, individual recognition is enabled through face recognition of images taken by the camera unit 503, proximity communication with a user-owned terminal, and so forth. Also, user state is defined by image recognition of images taken by the camera unit 503, and signal analysis of the distance sensor 507. User states are divided mainly into two states: “There is a user (present)” or “There is no user (not present).” The two types of the “There is a user” state are: “User is watching TV (screen of the display unit 603) (viewing)” and “User is not watching TV (not viewing).” The “User is watching TV” state is further subdivided into two states: “User is operating TV (operating)” and “User is not operating TV (no operation).”

The display GUI optimization unit 2310 references the device input method database in the recording unit 140 when distinguishing user state. Also, according to the user state and position of the user distinguished, GUI display (framework/density) database and content database in the recording unit 140 are also referenced when optimizing the display GUI.

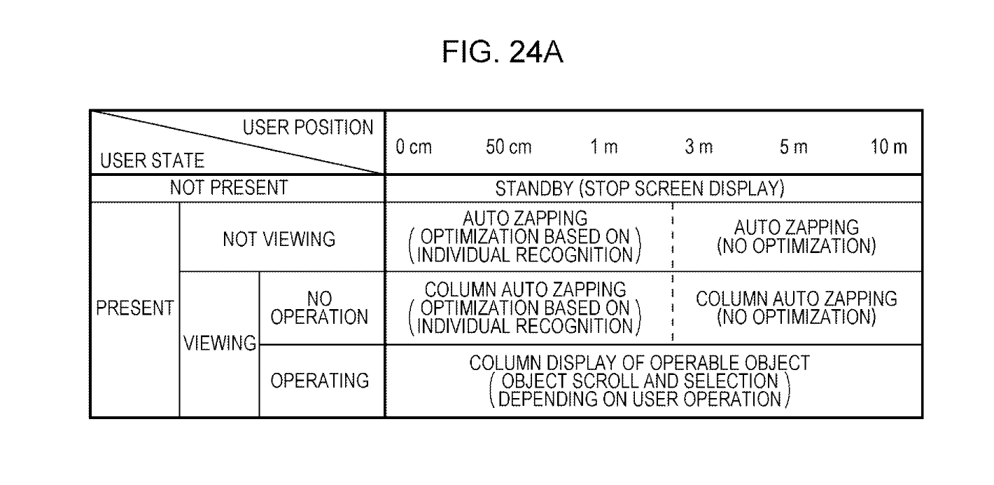

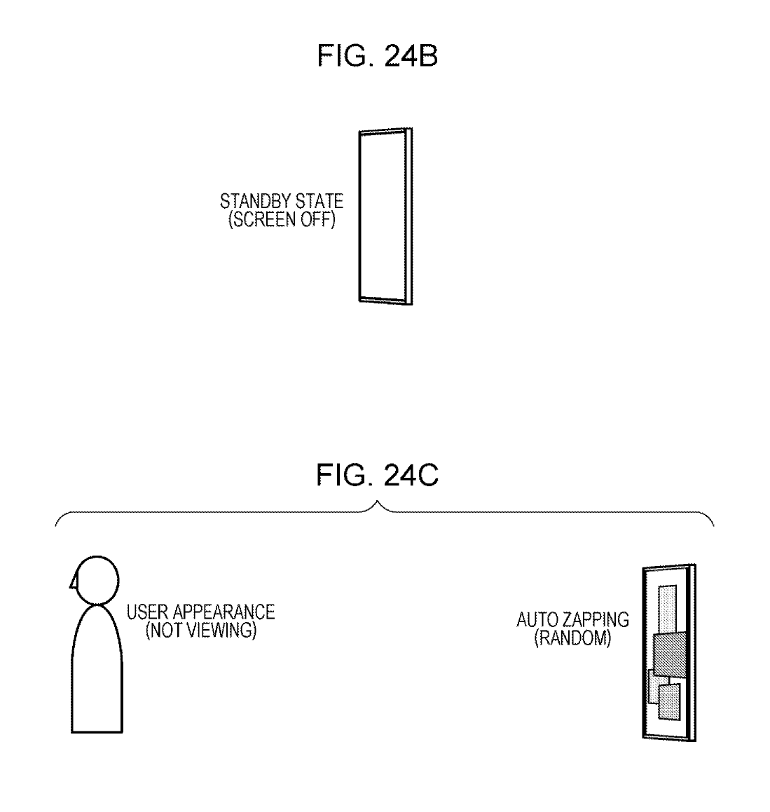

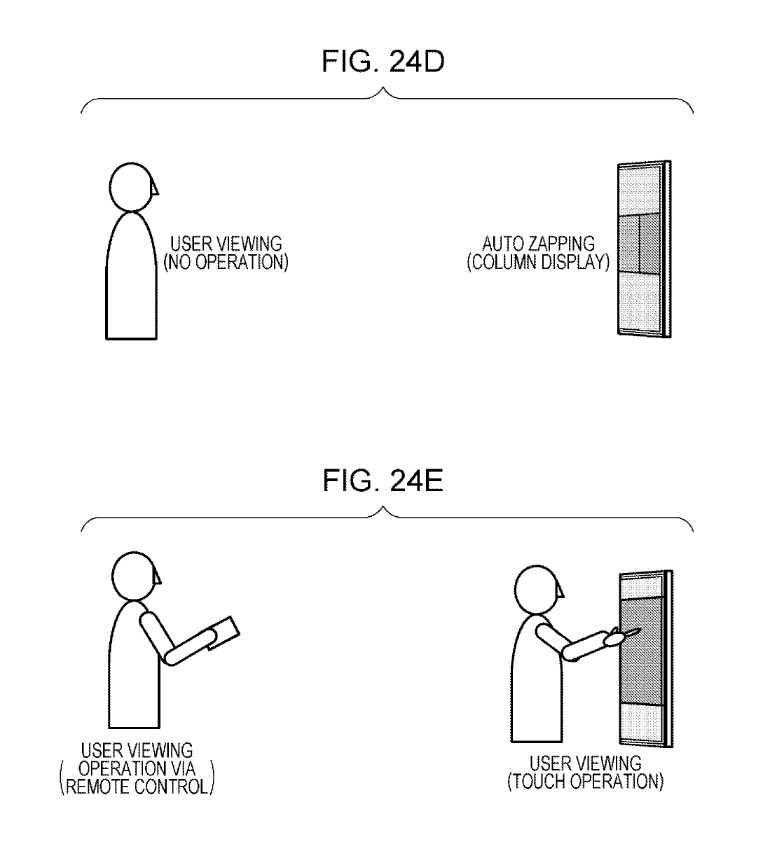

FIG. 24A is a diagram containing a table summarizing optimization processing of a GUI display, according to user position obtained by the display GUI optimization unit 2310 and user state. Also, FIG. 24B through 24E illustrate screen transitions of the information processing device 100 according to user position and user state.

When in the “There is no user” state, the display GUI optimization unit 2310 stops screen display of the display unit 603, and stands by until a user presence is detected (Refer to FIG. 24B).

When in the “There is a user” and “User is not watching TV” state, the display GUI optimization unit 2310 selects “auto zapping” as the optimal display GUI (refer to FIG. 24C). Auto zapping randomly displays various operable objects to catch the user's interest and encourage the desire to watch TV. Operable objects used in zapping include not only TV broadcast program content received by the television tuner unit 170, but also network content obtained via the Internet from the communication unit 150, emails and messages and so forth from other users, in which such multiple operable objects are selected by the display GUI optimization unit 2310 based on the content database.

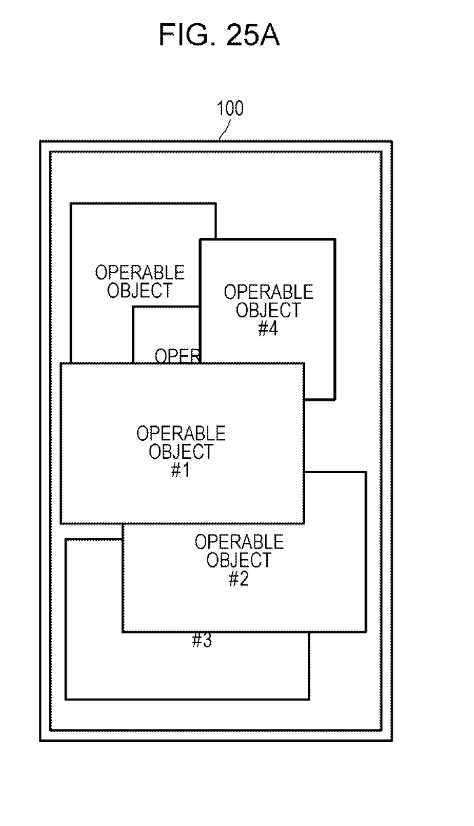

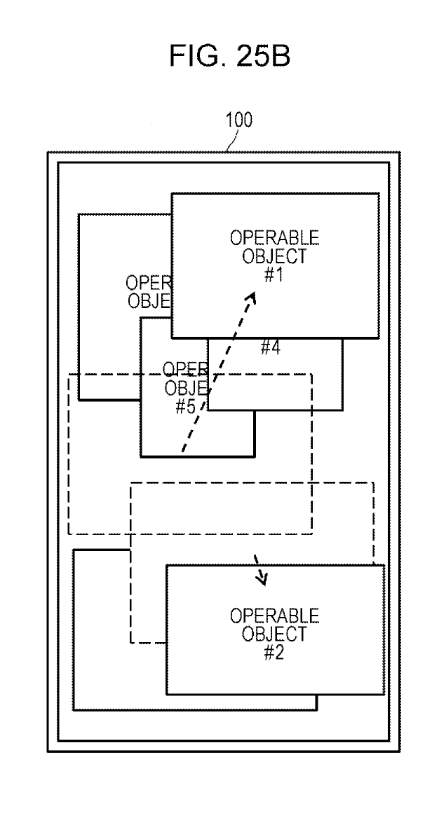

FIG. 25A illustrates an example of a display GUI which is auto zapping. The display GUI optimization unit 2310 can change the position and size (i.e. degree of exposure) of each operable object displayed on the screen moment by moment, as shown in FIG. 25B, in order to subconsciously encourage the user. Also, when individual recognition is enabled as the user position becomes near, the display GUI optimization unit 2310 may select the operable objects for auto zapping using on the recognized individual.

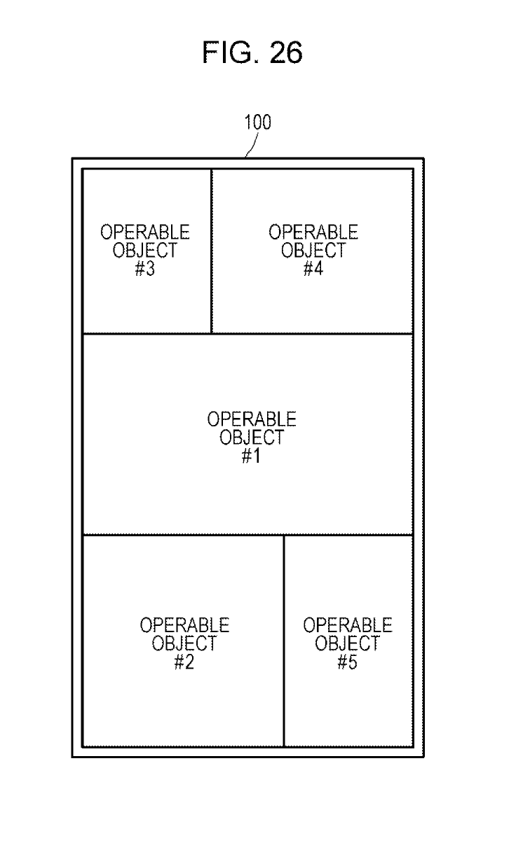

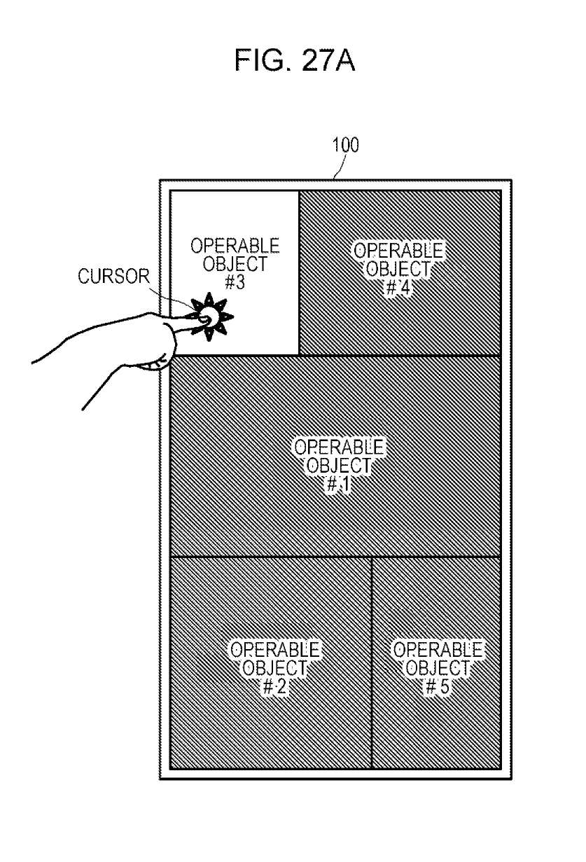

When in the “User is watching TV” and “User is not operating the TV” state, the display GUI optimization unit 2310 can still select the “auto zapping” as the optimal display GUI (Refer to FIG. 24D). However, different from what was previously described, multiple operable objects selected based on the content database are arranged in order, such as in columns as shown in FIG. 26, in order to make the display content of each operable object easy to confirm. Also, when individual recognition is enabled as the user position becomes near, the display GUI optimization unit 2310 may select the operable objects for auto zapping using on the recognized individual information. Also, the display GUI optimization unit 2310 may control the information density of the display GUI, based on user position, in such a manner as: when the user is far, the information density of the GUI is controlled; and as the user becomes near, the information density of the GUI is increased.

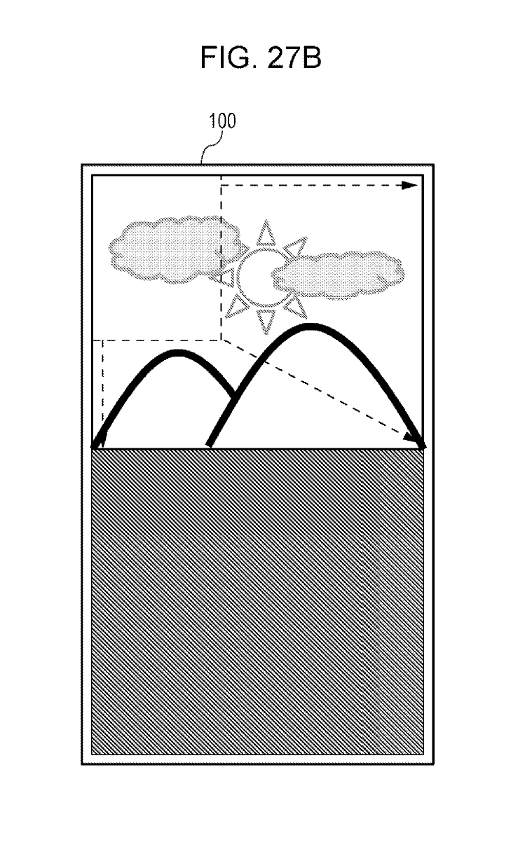

In contrast, when in the “User is watching TV” and “User is operating TV” state, the user is operating the information processing device 100 using the input method optimized by the input method optimization unit 2320 (refer to FIG. 24E). The input method can be for example, sending of remote control signals to the remote control reception unit 501, gestures to the camera unit 503, touching of touch panel to be detected by the touch detection unit 509, voice input into microphone 505, proximity input into the proximity sensor 511, and others. The display GUI optimization unit 2310 displays columns of operable objects as the optimal display GUI, according to user input operation, and can operate the scroll and selection of operable objects, according to user operation. As shown in FIG. 27A, a cursor is displayed in the position on the screen as instructed by the input method. Operable objects without a cursor can be thought to not be of interest to the user may have their brightness level lowered as illustrated by the diagonal line in the drawing, in order to express contrast with operable objects of interest (In FIG. 27A, a cursor placed on operable object #3 being touched by user's finger). Also, as shown in FIG. 27B, when the user selects an operable object with a cursor, this operable object may be displayed full screen (or enlarged display to the maximum size) (In FIG. 27B, the selected operable object #3 has an enlarged display).

The input method optimization unit 2320 performs optimization of the input method, which the user performs operation of the information processing device 100, according to user position and user state.

As described previously, user position is obtained by the distance detection method switched by the distance detection method switching unit 2330. As the user position becomes near, individual recognition can be made, through face recognition of images taken by the camera unit 503, proximity communication with a user-owned terminal, and so forth. Also, user state is defined based on image recognition of images taken by the camera unit 503, and signal analysis of the distance sensor 507.

The input method optimization unit 2320 references the device input method database in the recording unit 140 when distinguishing user state.

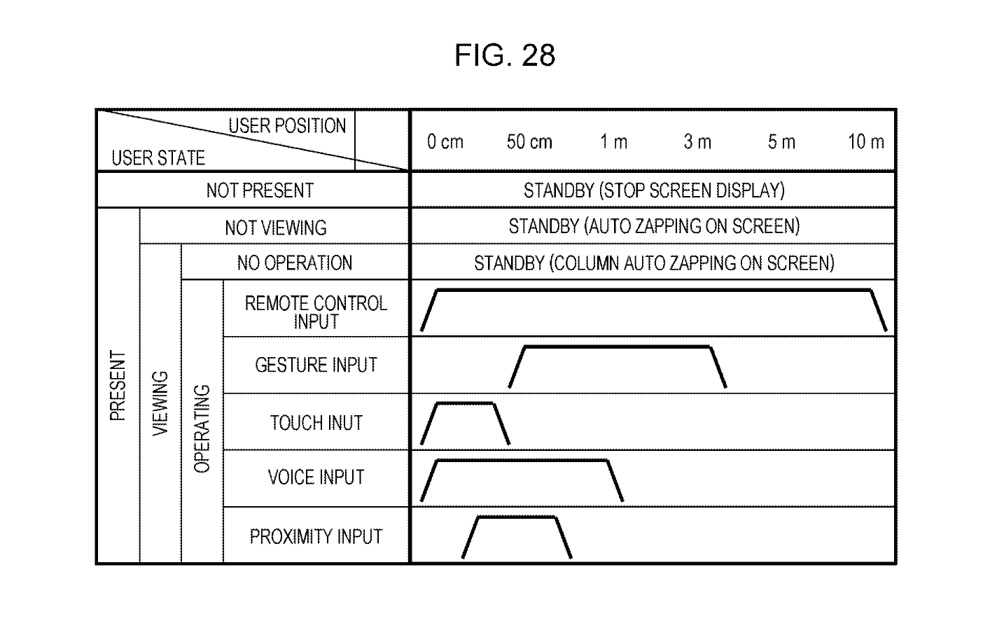

FIG. 28 is a diagram containing a table summarizing optimization processing of an input method, according to user position and user state obtained by the input method optimization unit 2320.

When in the “There is no user” state, “There is a user” and “User is not watching TV” state, and “User is watching TV” and “User is not operating TV” state, the input method optimization unit 2320 stands by until user operation begins.

Also, when in the “User is watching TV” and “User is operating TV” state, the input method optimization unit 2320 optimizes each input method, based mainly on user position. The input method includes for example, remote control input to the remote control reception unit 501, gesture input to the camera unit 503, touch input detected by the touch detection unit 509, voice input into microphone 505, and proximity input into the proximity sensor 511, and others.

The remote control reception unit 501 starts for all user positions (i.e. almost constantly), and stands by to receive remote control signals.

The recognition accuracy for images taken by the camera unit 503 lessens as the user distances themselves. Also, if the user is too close, the figure of the user can easily stray from the field of vision of the camera unit 503. Here, the input method optimization unit 2320 will turn on gesture input into the camera unit 503 when the user position is in a range from tens of centimeters to a few meters.

Touch to the touch panel superimposed on the screen of the display unit 603 is limited to the range that the user's hand can reach. Here, the input method optimization unit 2320 will turn on touch input into the touch detection unit 509 when the user position is in a range of tens of centimeters. Also, the proximity sensor 511 can detect a user, even when not touching, up to tens of centimeters. Therefore, the input method optimization unit 2320 will turn on proximity input when the user position is farther than for touch input.

The recognition accuracy for input voice into microphone 505 lessens as the user distances themselves. Here, the input method optimization unit 2320 will turn on gesture input into the camera unit 503 when the user position is in a range up to a few meters.

The distance detection method switching unit 2330 performs processing to switch the method used to detect user position and distance of the user to the information processing device 100, according to user position.

The distance detection method switching unit 2330 references the cover range database for each detection method in the recording unit 140, when distinguishing user state.

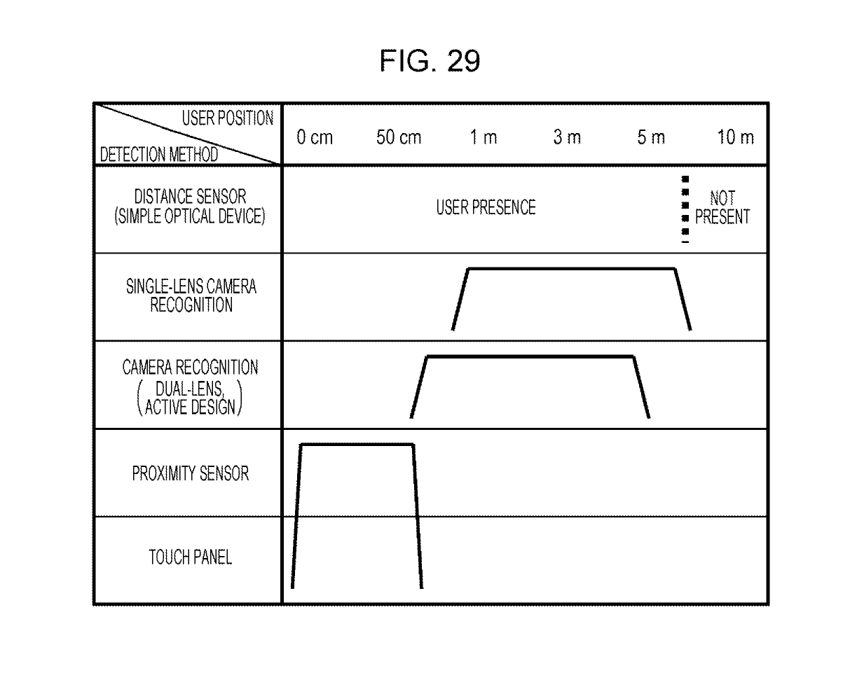

FIG. 29 is a diagram containing a table summarizing switching processing of a distance detection method, according to user position obtained by the distance detection method switching unit 2330.

The distance sensor 507 is configured of a simple, low power sensing device, such as a PSD sensor, pyro electric sensor, or a basic camera, for example. The distance detection method switching unit 2330 keeps the distance sensor 507 on constantly, as it constantly monitors for the presence of a user within a radius of 5 to 10 meters, for example, from the information processing device 100.

When the camera unit 503 employs a single-lens type, the image recognition unit 504 performs people recognition, face recognition, and user movement recognition by background differencing. The distance detection method switching unit 2330 will turn on recognition (distance detection) function by the image recognition unit 504, when the user position is in a range from 70 centimeters to 6 meters, which enables sufficient recognition accuracy to be obtained based on taken images.

Also, when the camera unit 503 employs a dual-lens type or active type, the distance detection method switching unit 2330 will turn on recognition (distance detection) function by the image recognition unit 504, when the user position is in a range from just under 60 centimeters to 5 meters, which enables the image recognition unit 504 to obtain sufficient recognition accuracy.

Also, if the user is too close, the figure of the user can easily stray from the field of vision of the camera unit 503. Here, the distance detection method switching unit 2330 may turn off the camera unit 503 and the image recognition unit 504 when the user is too close.

Touch to the touch panel superimposed on the screen of the display unit 603 is limited to the range that the user's hand can reach. Accordingly, the distance detection method switching unit 2330 will turn on the distance detection function of the touch detection unit 509 when the user position is in a range to tens of centimeters. Also, the proximity sensor 511 can detect a user, even when not touching, up to tens of centimeters. Therefore, the distance detection method switching unit 2330 will turn on the distance detection function when the user position is farther than for touch input.

From a design perspective, the information processing device 100, which is equipped with multiple distance detection methods, and the purpose of distance detection methods that detect farther than a few meters, or ten meters, is to confirm the presence of a user. This has to be on at all times, and therefore it is preferable to use a low power device. Reversely, distance detection methods that detect at close range within one meter can be combined with recognition functions such as face recognition and people recognition by obtaining information high in density. Recognition processing and such consumes a considerable amount of power, however, so it is preferable to turn this function off when sufficient recognition accuracy is unobtainable.

### D. Real Size Display of Objects According to Monitor Performance

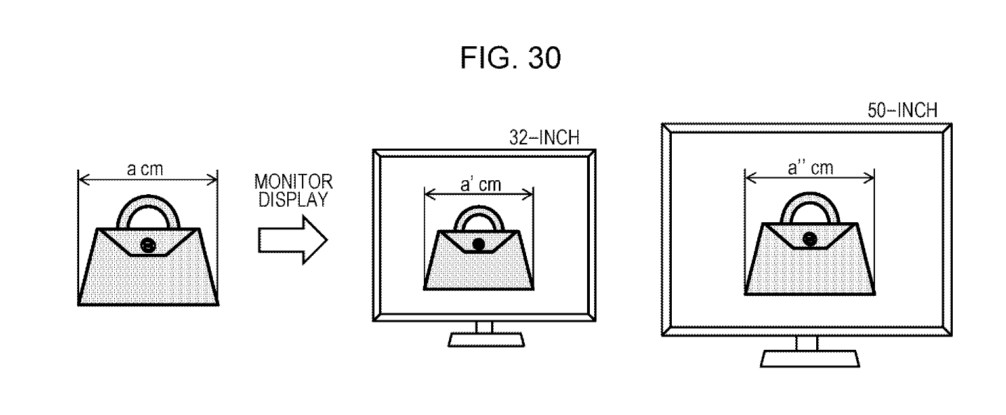

With physical object display systems according to the related art, actual object images are displayed on the screen without considering real size information for the object. For this reason, the size of objects displayed change according to the size and resolution (dpi) of the screen. For example, the width a′ of a bag with a width of a centimeters when displayed on a 32-inch monitor will be different than width a″ when displayed on a 50-inch monitor (a≠a′≠a″) (Refer to FIG. 30).

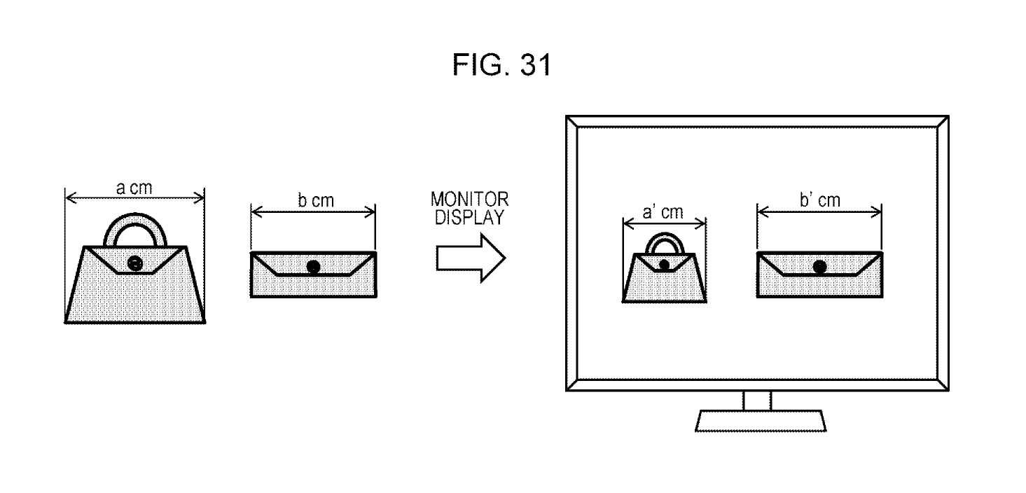

Also, when simultaneously displaying images of multiple objects on the same monitor screen, if the real size information of each object is not considered, the relation in size of the corresponding objects is not displayed correctly. For example, when a bag with a width of a centimeters and a pouch with a width of b centimeters is simultaneously displayed on the same monitor screen, the bag will be displayed in a′ centimeters while the pouch will be displayed in b′ centimeters, the corresponding relation in size will not be displayed correctly (a:b≠a′:b′) (Refer to FIG. 31).

For example, when net shopping for products, if the real size of the sample image is not duplicable, a user will have difficulty in correctly assessing if it fits to his/her figure, which may result in the purchase of the wrong product. Also, when trying to simultaneously purchase multiple products by net shopping, if the relation in size of the sample images is not displayed correctly when simultaneously displaying sample images of each product on the screen, a user will have difficulty in correctly assessing if the combination of products fits, which may result in the purchase of an unsuitable combination of products.

In regards to this, the information processing device 100 as related to the present embodiment, manages the real size information of objects which are desired to be displayed, and size and resolution (pixel pitch) information of the screen of the display unit 603, object images are consistently displayed on the screen in real size, even when the size of objects and screens changes.

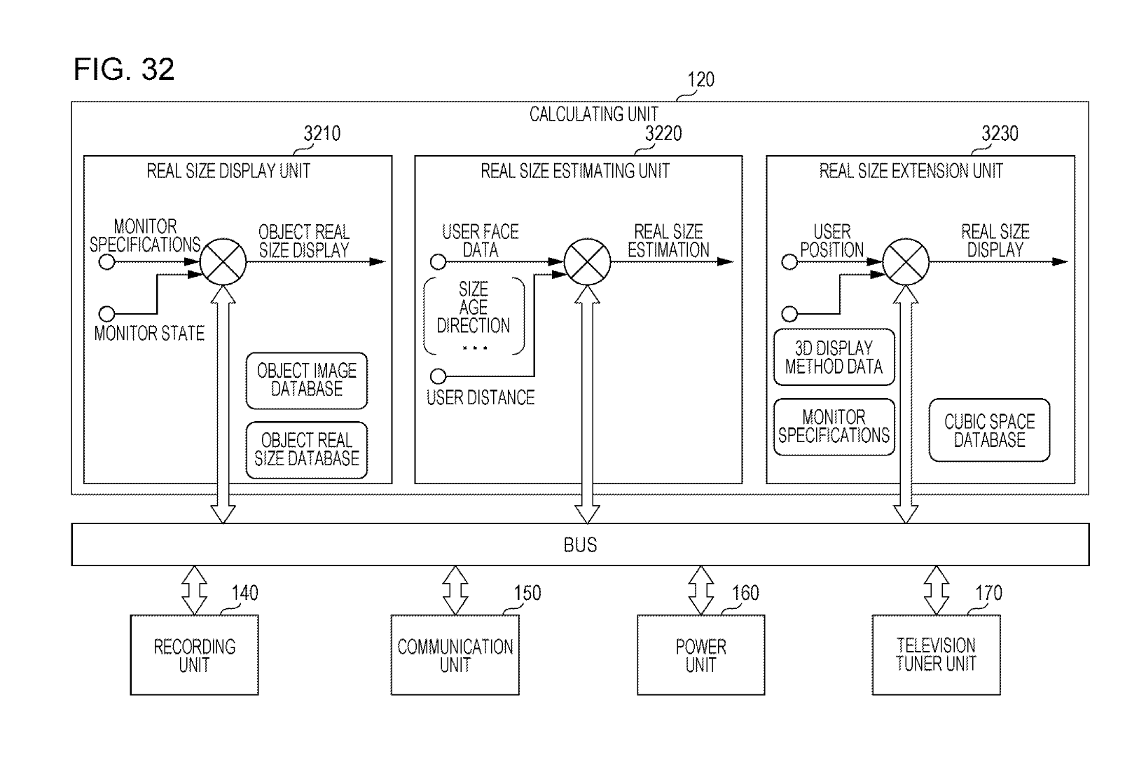

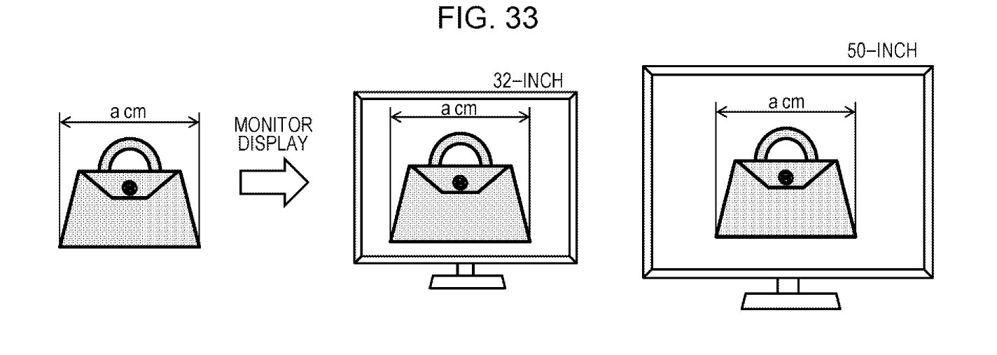

FIG. 32 illustrates an internal configuration for the calculating unit 120 to perform real size display processing on objects, according to monitor capabilities. The calculating unit 120 is equipped with a real size display unit 3210, a real size estimating unit 3220, and a real size extension unit 3230. Note however, that at least one function block from among the real size display unit 3210, the real size estimating unit 3220, and the real size extension unit 3230 can be assumed to be realized on a cloud server connected through the communication unit 150.

The real size display unit 3210 consistently displays in real size, according to the size and resolution (pixel pitch) of the screen of the display unit 603, and by taking into consideration the real size information of each object when simultaneously displaying images of multiple objects on the same monitor screen. Also, the real size display unit 3210 correctly displays the relation in size of corresponding objects when simultaneously displaying images of multiple objects on the screen of the display unit 603.

The real size display unit 3210 reads monitor specifications such as the size and resolution (pixel pitch) of the screen of the display unit 603 from the recording unit 140. Also, the real size display unit 3210 obtains monitor state such as direction and slope of the screen of the display unit 603 from the rotation and installation mechanism unit 180.

Also, the real size display unit 3210 reads images of objects desired to be displayed from the object image database in the recording unit 140, and also reads real size information for these objects from the object real size database. Note however, that the object image database and object real size database could also be on a database server connected through the communication unit 150.

Next, the real size display unit 3210 processes conversion of object images, based on monitor capabilities and monitor state to display objects desired to be displayed in real size on the screen of the display unit 603 (or to have the correct relation in size for multiple corresponding objects). That is to say, even when displaying the same object image on screens with different monitor specifications, a=a′=a″ as shown in FIG. 33.

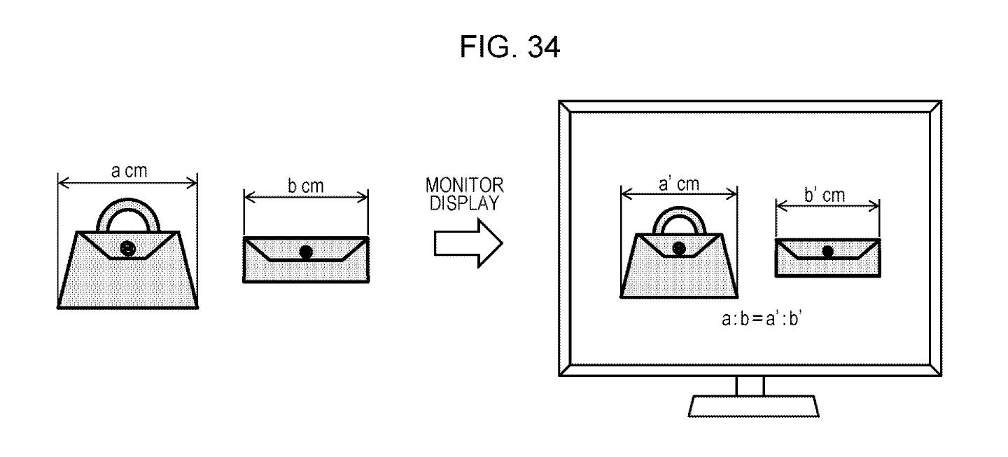

Also, when simultaneously displaying the images of two objects with different real sizes on the same screen, the real size display unit 3210 will correctly display the corresponding relation in size, i.e. a:b=a′:b′, as shown in FIG. 34.

If, for example, a user is net shopping for products through the display of sample images, the information processing device 100 can regenerate a real size display of the object as described previously, and can display the correct relation in size of multiple sample images, which enables the user to correctly assess if the products fit, in turn causing the change of incorrect product selections to decrease.

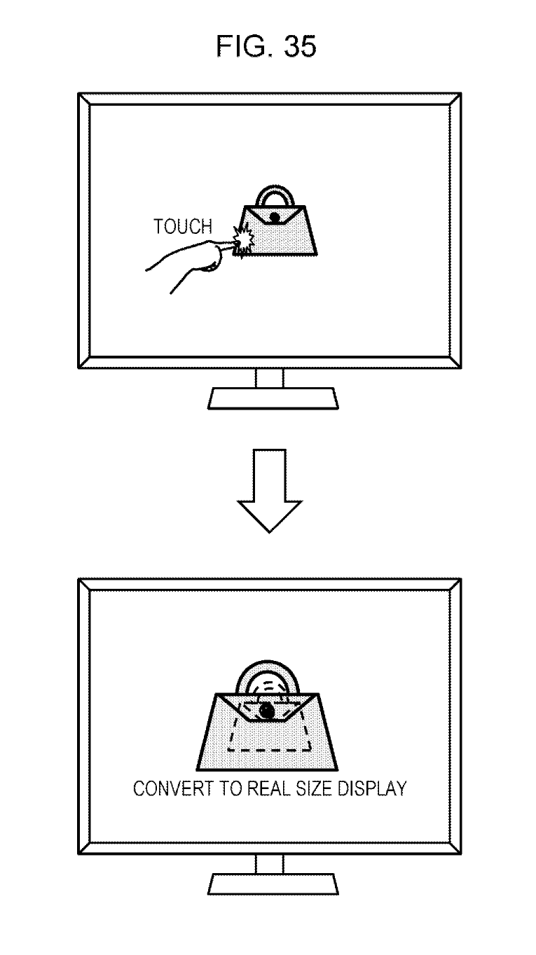

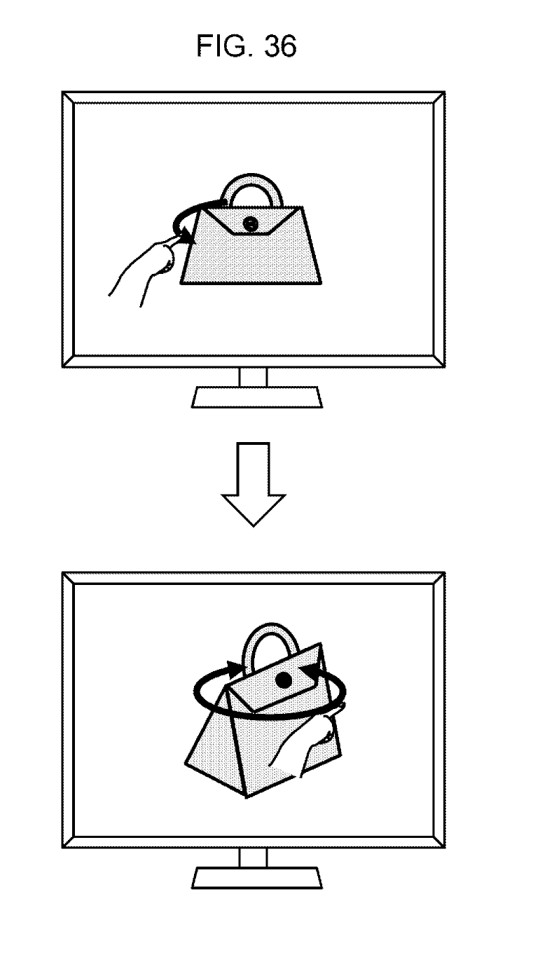

Additional description will be made of a suitable example of the application for net shopping that displays object images in real size with the real size display unit 3210. As a response to a user touching images of desired products from a screen display of a catalog, the images of these products change to the real size display (Refer to FIG. 35). Also, in response to user touch operation of the image displayed in real size, a display can be made by rotation and format conversion, and changing of the direction of the real size object (refer to FIG. 36).

Also, the real size estimating unit 3220 performs processing to estimate the real size of objects for which the real size information is not available, even after referencing the object real size database for people taken by the camera unit 503, and so forth. For example, if the object for which the real size is to be estimated is a user's face, the user's real size will be estimated, based on user position obtained by the distance detection method switched by the distance detection method switching unit 2330, and user face data such as the size, age, and direction of the user's face obtained by image recognition of images taken by the camera unit 503 from the image recognition unit 504.

The estimated user real size information becomes feedback to the real size display unit 3210, and is stored in the object image database, for example. The real size information estimated from user face data is then used in real size displays by the real size display unit 3210 in cases for subsequent monitor capabilities.

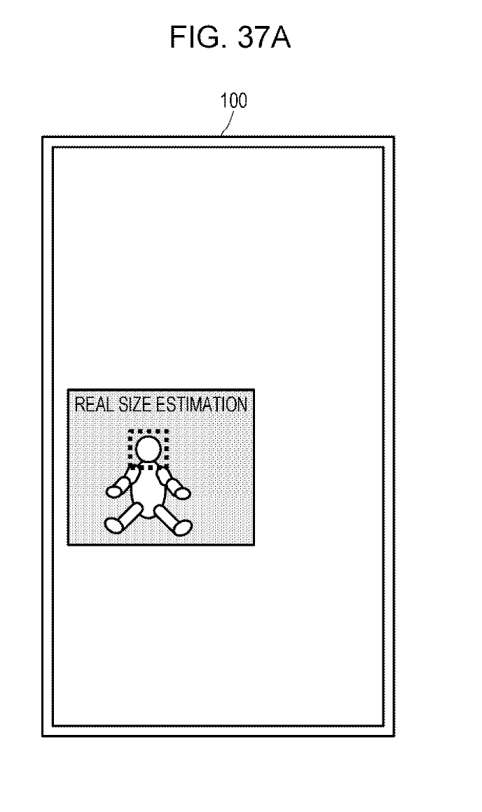

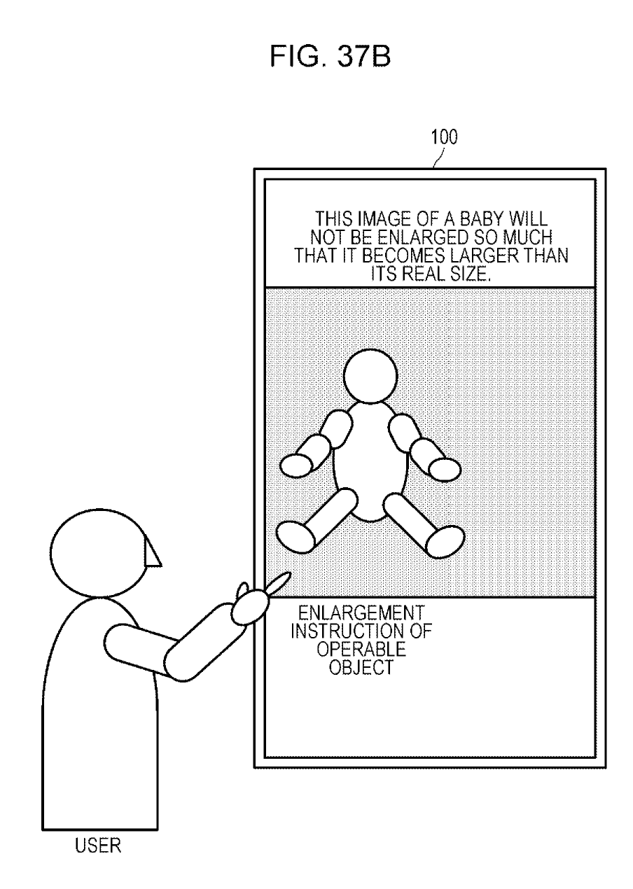

As shown in FIG. 37A for example, when displaying the operable object that includes the taken image of the photographic subject (baby), the real size estimating unit 3220 estimates the real size based on this face data. Afterwards, when enlargement display of this operable object occurs by touch operation or similar by the user, the photographic subject will not be enlarged so much that it is becomes larger than the real size, as shown in FIG. 37B. That is to say, the image of the baby will not be enlarged unnaturally so, and the reality of the video is maintained.

Also, when content taken by the camera unit 503 and network content is displayed by the display unit 603 juxtaposed or superimposed on the screen, by normalization processing of content video based on the estimated real size, a balanced juxtaposed or superimposed display can be realized.

Furthermore, the real size extension unit 3230 further realizes real size display of objects made on the screen of the display unit 603 in 3D, i.e. depth direction, with the real size display unit 3210. Also, when displaying 3D by dual-lens format or light beam reconstruction method in horizontal direction only, the desired result can only be obtained at the viewing position assumed at the time the 3D video is generated. With the omnidirectional light beam reconstruction method, an actual size display can be made from any position.

Also, the real size extension unit 3230 can obtain the same kind of real size display from any position, by detecting the perspective position of the user and correcting the 3D video to this position, even with a dual-lens type or light beam reconstruction method in horizontal direction only.

For example, reference Japanese Unexamined Patent Application Publication Nos. 2002-300602, 2005-149127, and 2005-142957 already transferred to the present assignee.

### E. Simultaneous Display of Image Groups

With this display system, there are cases where video content from multiple sources is simultaneously displayed on the same screen in a juxtaposed or superimposed format. For example, such cases as (1) a case when performing video chat among multiple users, or (2) a case during a yoga or other lesson, video of the user themselves taken by the camera unit 503 is displayed simultaneously with video of the instructor played from recordable media such as DVD (or streaming playback via a network), or (3) a case where video of the user themselves taken by the camera unit 503 is combined and displayed with sample images of products to enable fitting during net shopping, can be given.

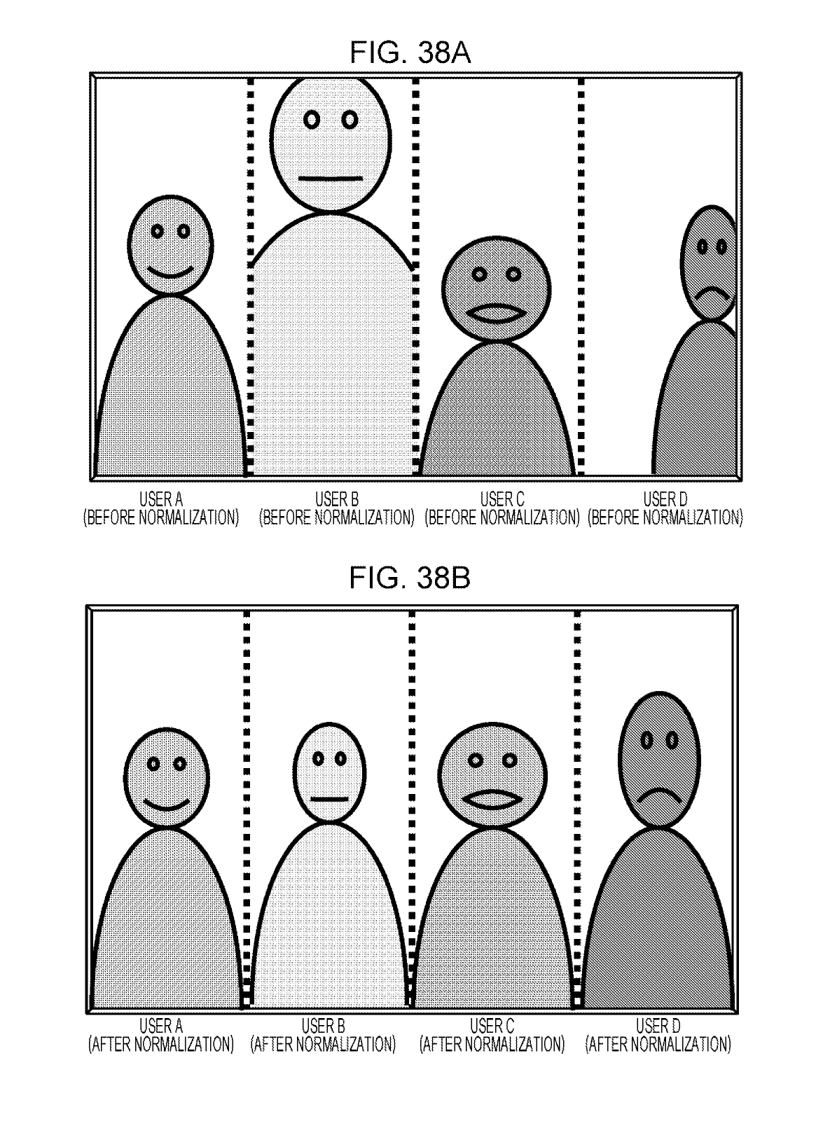

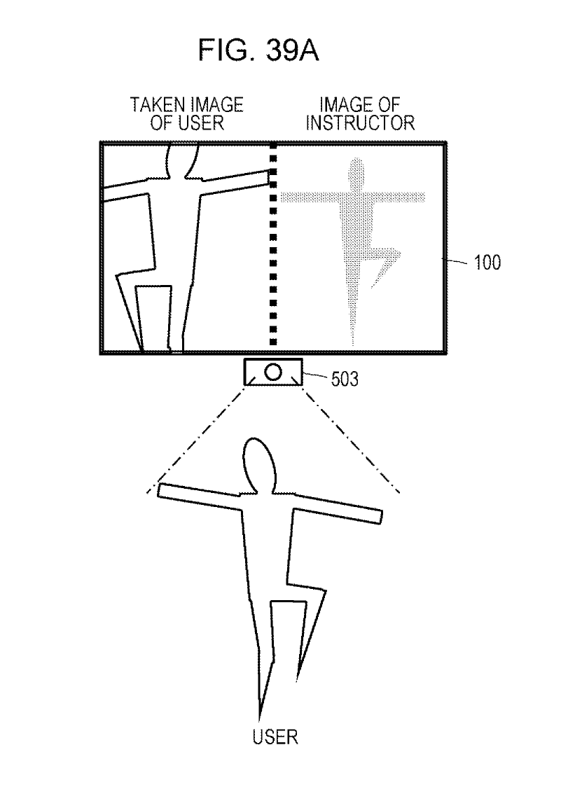

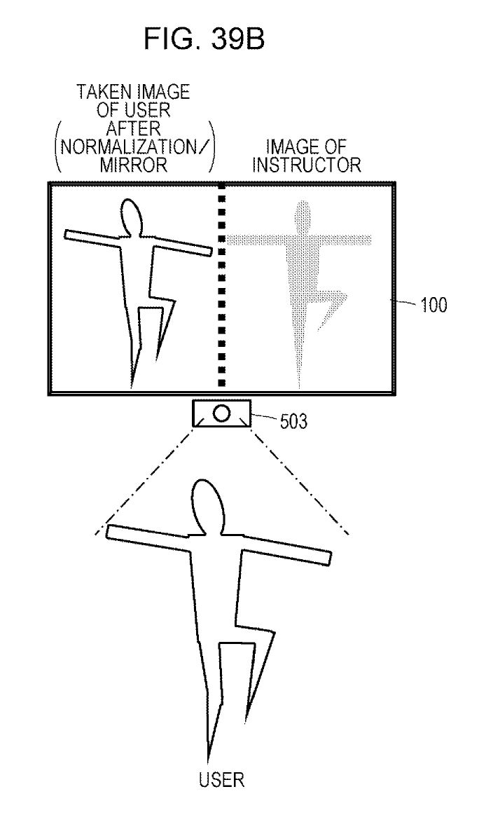

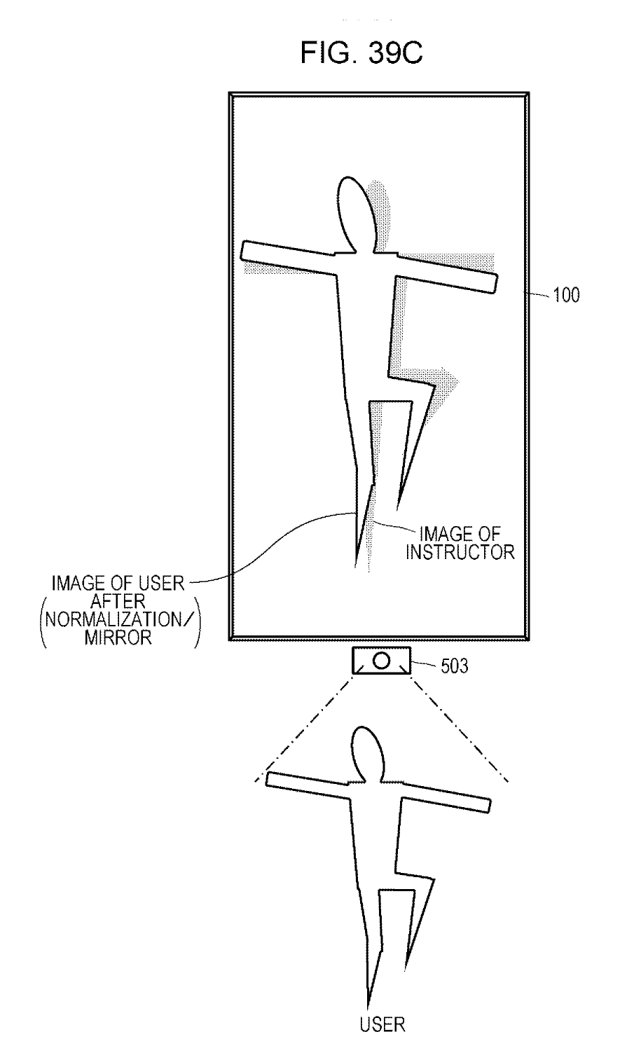

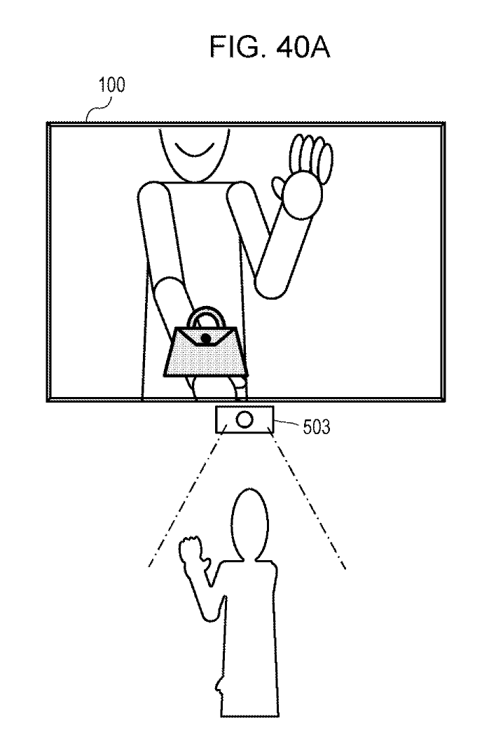

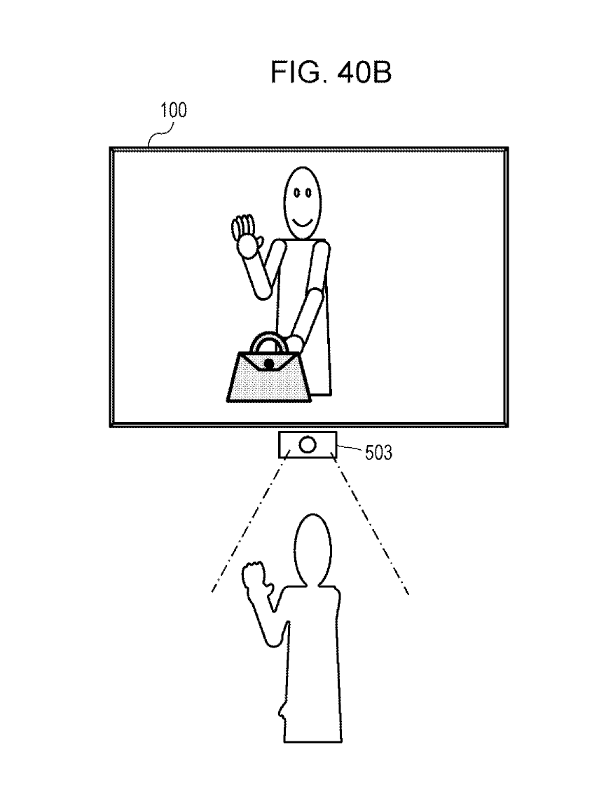

For either cases (1) or (2) described above, if the relation in size for images displayed simultaneously is not correct, users will have difficulty in using the displayed video adequately. For example, if size and position of user faces are inconsistent among users video chatting (FIG. 38A), the quality of face-to-face experience between chatting partners breaks down, and conversation dies. Also, if a user's figure does not match with the size and position of the instructor's figure (FIG. 39A), the user will have difficulty in telling the difference between his/her movement and the instructor's movement, will have difficulty in telling which points to correct or improve, and will have difficulty in gaining enough achievement from the lesson. Also, if product sample images and video of the user's figure, who has taken a pose as though they were grabbing the product, do not have correct relation in size, and do not overlap in the proper place, it is difficult for the user to judge whether the product works for themselves, and are unable perform suitable fitting (FIG. 40A).

In regards to this, when video content from multiple sources are juxtaposed or superimposed, the information processing device 100 as related to the present embodiment normalizes the different images using information such as image scale and target region to display juxtaposed or superimposed. When normalizing, image processing is performed such as digital zoom processing regarding digital image data from still images, moving images, and so forth. Also, when one of the images to be juxtaposed or superimposed is taken by the camera unit 503, optical control such as pan, tilt, and zoom is performed on the actual camera.

Normalization processing of images can be easily realized using information such as size, age, and direction of a face, obtained by face recognition, and information on body shape and size obtained by individual recognition. Also, when displaying multiple images juxtaposed or superimposed, by automatically performing rotation processing and mirroring of certain images, adapting with other images is facilitated.

FIG. 38B illustrates a situation in which the size and position of faces of users, who are video chatting, have been made to be consistent, due to normalization processing among multiple images. Also, FIG. 39B illustrates a situation where, when displayed on a screen juxtaposed, the figure of a user is consistent with the size and position of the figure of the instructor, due to normalization processing among multiple images. Also, FIG. 40B illustrates a situation where, due to normalization processing among multiple images, a sample image of a product is displayed so that the video of a user, who has taken a pose as though they were grabbing the product, is displayed with the correct relation in size and overlapping in the right place. Furthermore, in FIG. 39B and FIG. 40B, mirroring is also performed in addition to normalization processing of relation in size, so that a user can easily correct his/her posture from images taken by the camera unit 503. Also, rotation processing is also performed when appropriate. Also, when the figure of the user and the figure of the instructor can have normalization processing, a superimposed display can be made as shown in FIG. 39C, rather than being displayed juxtaposed as shown in FIG. 39B, which enables the user to more easily visualize the difference between his/her posture and the instructor's posture.

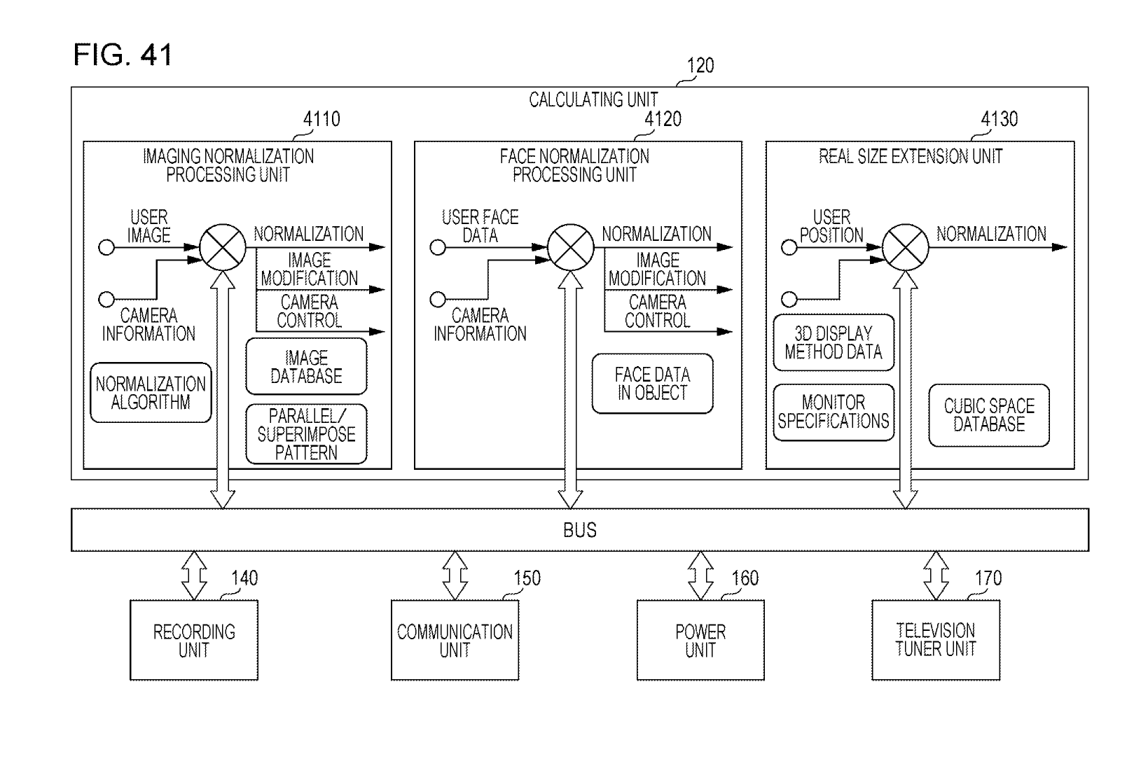

FIG. 41 illustrates an internal configuration for the calculating unit 120 to perform normalization processing. The calculating unit 120 is equipped with an inter-image normalization processing unit 4110, a face normalization processing unit 4120, and a real size extension unit 4130. Note however, that at least one function block from among the inter-image normalization processing unit 4110, the face normalization processing unit 4120, and the real size extension unit 4130 can be assumed to exist on a cloud server connected through the communication unit 150.

The inter-image normalization processing unit 4110 performs normalization processing to correctly display the relation in size between face images of users and other objects from among multiple images.

The inter-image normalization processing unit 4110 inputs images of users taken by the camera unit 503, through the input interface integration unit 520. In this case, camera information such as pan, tilt, and zoom of the camera unit 503 when photographing a user is also obtained. Also, the inter-image normalization processing unit 4110 obtains, while obtaining images of other objects to be displayed juxtaposed or superimposed with user images, the juxtaposed or superimposing pattern for the images of the users and other objects from the image database. The image database can exist in the recording unit 140, or can exist on a database server accessed through the communication unit 150.

Next, the inter-image normalization processing unit 4110 performs image processing such as enlargement, rotation, and mirroring on user images according to the normalization algorithm so that the relation in size and position with other objects is correct, and the, the inter-image normalization processing unit 4110 also generates camera control information to perform control such as pan, tilt, zoom, and other functions of the camera unit 503 to take suitable images of users. Processing by the inter-image normalization processing unit 4110 allows, as shown in FIG. 40B for example, the relation in size between user images and images of other objects to be displayed correctly.

The face normalization processing unit 4120 performs normalization processing to correctly display the relation in size between face images of a user taken by the camera unit 503 and face images within other operable objects (for example, face of an instructor in images played back from recordable media, and faces of the other users video chatting).

The face normalization processing unit 4120 inputs images of users taken by the camera unit 503, through the input interface integration unit 520. In this case, camera information such as pan, tilt, and zoom at the camera unit 503 is also obtained at the time of photographing a user. Also, the face normalization processing unit 4120 obtains face images in other operable objects to be displayed juxtaposed or superimposed with taken images of the user, through the recording unit 140 or the communication unit 150.

Next, face normalization processing unit 4120 performs image processing such as enlargement, rotation, and mirroring on user images so that the relation in size between mutual face images is correct, and the face normalization processing unit 4120 also generates camera control information to perform control of pan, tilt, zoom, at the camera unit 503 to take suitable images of users. Processing by the face normalization processing unit 4120 allows, as shown in FIG. 38B, FIG. 39B, and FIG. 39C for example, the relation in size between user images and images of other objects to be displayed correctly.

Furthermore, the real size extension unit 4130 further realizes a juxtaposed or superimposed display of multiple images made on the screen of the display unit 603 in 3D, i.e. depth direction, with the inter-image normalization processing unit 4110. Also, when displaying 3D by dual-lens format or light beam reconstruction method in horizontal direction only, the desired result can only be obtained at the viewing position assumed at the time the of 3D video being generated. With the omnidirectional light beam reconstruction method, an actual size display can be made from any position.

Also, the real size extension unit 4130 can obtain the same kind of real size display from any angle, by detecting the perspective position of the user and correcting the 3D video to this position, even with a dual-lens format or light beam reconstruction method in horizontal direction only.

For example, reference Japanese Unexamined Patent Application Publication Nos. 2002-300602, 2005-149127, and 2005-142957 already transferred to the present assignee.

### F. Display Method for Video Content Regarding Rotating Screens

As previously described, the main unit of the information processing device 100 according to the present embodiment is installed in a state in which it can be rotated on and removed from the wall by using, for example, the rotation and installation mechanism unit 180. Also, when the information processing device 100 is powered on, or rather when the main unit is rotated during display of operable objects by the display unit 603, and according to this, rotation processing of operable objects is performed to enable users to observe operable objects in the correct position.

The following describes a method to optimally adjust the display format of video content, regarding any rotation angle and transition process thereof for the main unit of the information processing device 100.

As display formats of video content, regarding any rotation angle and transition process for the screen, three cases can be given: (1) a display format where video content is not completely seen for some arbitrary rotation angle, and (2) a display format where content of interest within video content is maximized for each rotation angle, and (3) a display format where video content is rotated to eliminate invalid regions.

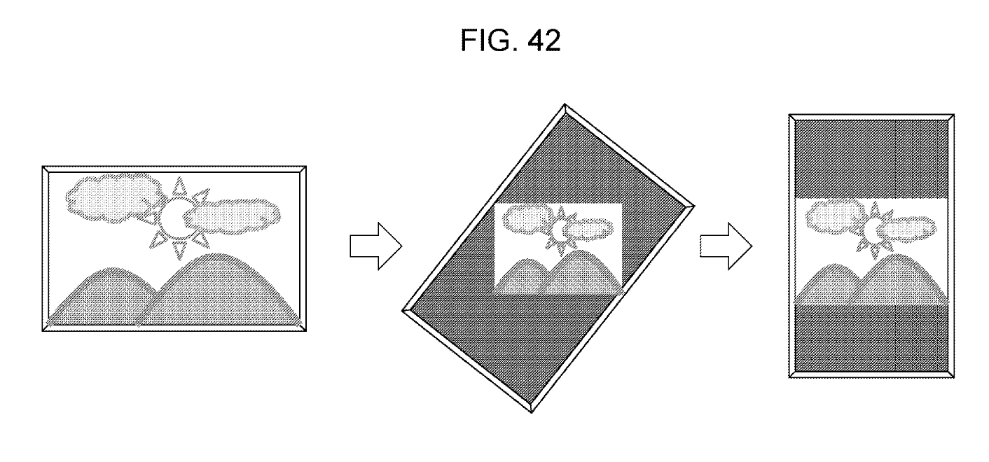

FIG. 42 illustrates a display format where the entire region of video content is displayed in a way that the video content is not completely seen at some arbitrary rotation angle, while the information processing device 100 (screen) is rotated counter-clockwise by 90 degrees. As shown in the drawing, when displaying horizontal video content on the screen in the horizontal state, if this is rotated counter-clockwise 90 degrees vertically, the video content will shrink, and an invalid region represented in black will also appear on the screen. Also, video content will be minimized during the process to transition the screen from horizontal to vertical.

If at least one part of video content can be seen clearly, there is a problem with copyrighted video content losing sameness. The display format as shown in FIG. 42 assures constant sameness for copyrighted work, regarding arbitrary angles and the transition process thereof. That is to say, protected content can have a suitable display format.

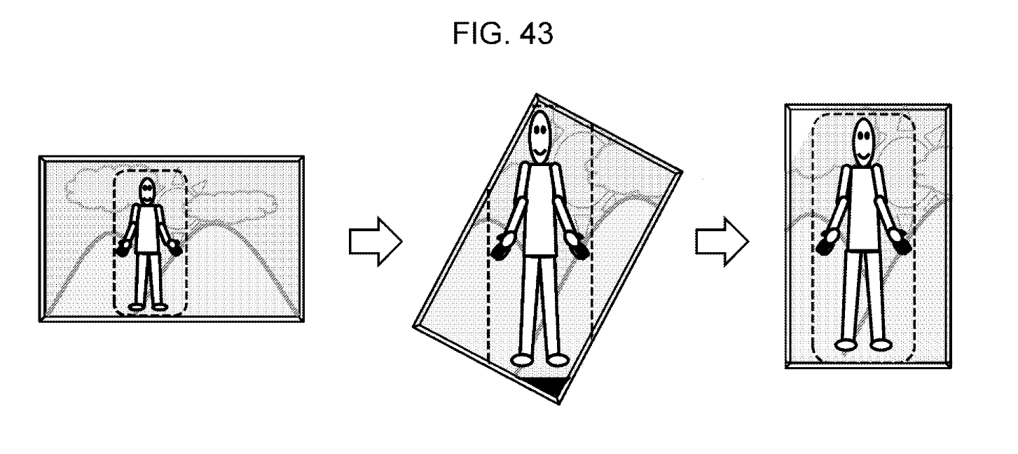

Also, FIG. 43 illustrates a display format where content of interest within video content is maximized for each rotation angle, while the information processing device 100 (screen) is rotated counter-clockwise by 90 degrees. In FIG. 43, the region of interest is set to the region including photographic subjects surrounded by a dotted line in the video content, and this region of interest is maximized for each rotation angle. The region of interest is vertical, and so by changing from horizontal to vertical, the video content is enlarged. Also, regarding the process to transition from horizontal to vertical, the region of interest is enlarged to the maximum in a diagonal direction of the screen. Also, regarding the process to transition from horizontal to vertical, an invalid region represented in black appears on the screen.

As a display format focused on the region of interest in video content, a modification can be conceived where video content is rotated while keeping the region of interest to the same size. As the screen rotates, the region of interest can be viewed as rotating smoothly, but this will cause the invalid region to enlarge.

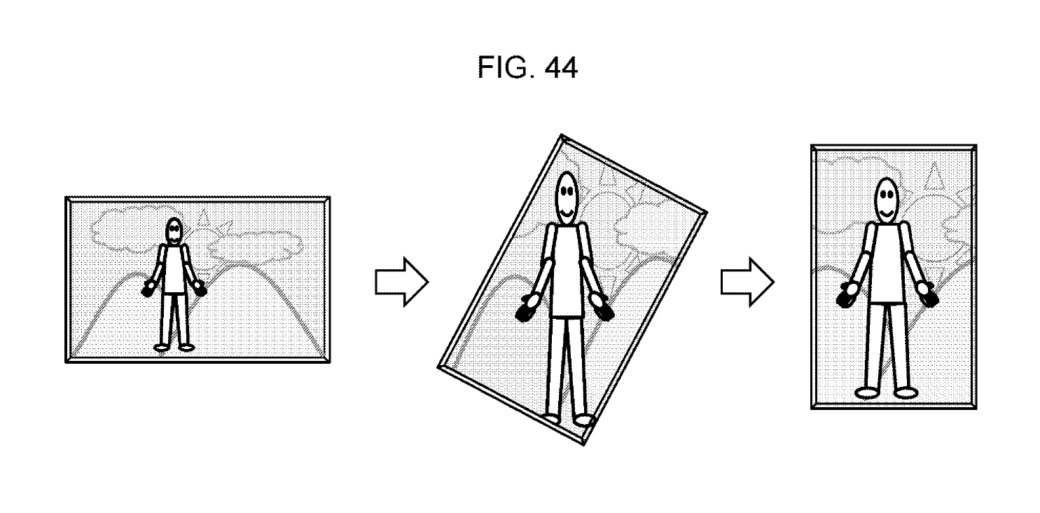

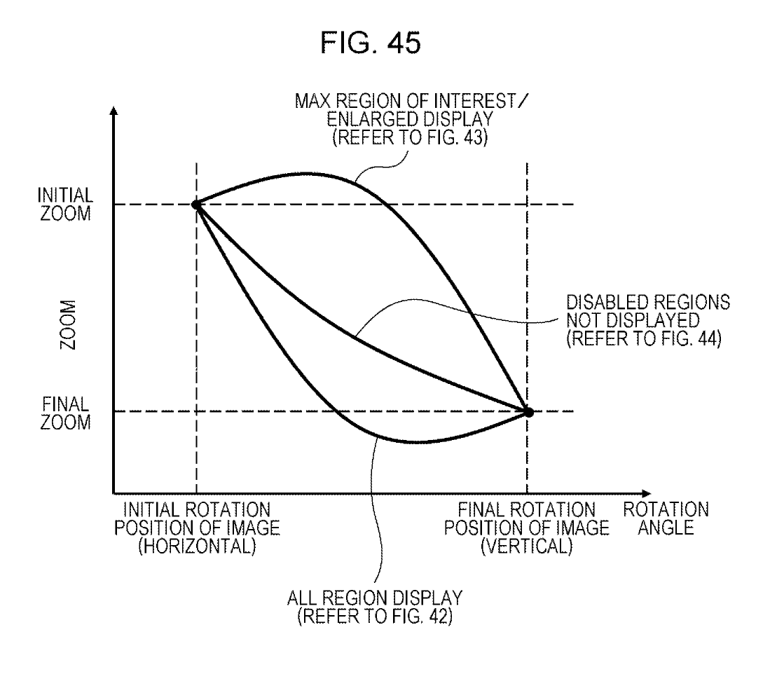

Also, FIG. 44 illustrates a display format where video content is rotated to eliminate invalid regions, while the information processing device 100 (screen) is rotated counter-clockwise by 90 degrees.

FIG. 45 illustrates the relationship of the zoom ratio of video content for the rotation position regarding each display format shown in FIG. 42 through FIG. 44. With the display format shown in FIG. 42 where video content is not clearly seen for some arbitrary angle, content can be protected, but a large invalid region will result during the transition process. Also, there is concern that users will sense a difference because of the reduction of video during the transition process. With the display format shown in FIG. 43 where the region of interest in video content is maximized at each rotation angle, the region of interest can be displayed smoothly during the transition process to rotate the screen, but invalid regions will result during the transition process. Also, with the display format shown in FIG. 44, though invalid regions do not occur during the transition process, the video content is greatly enlarged, which could give an unnatural impression to the observing users.

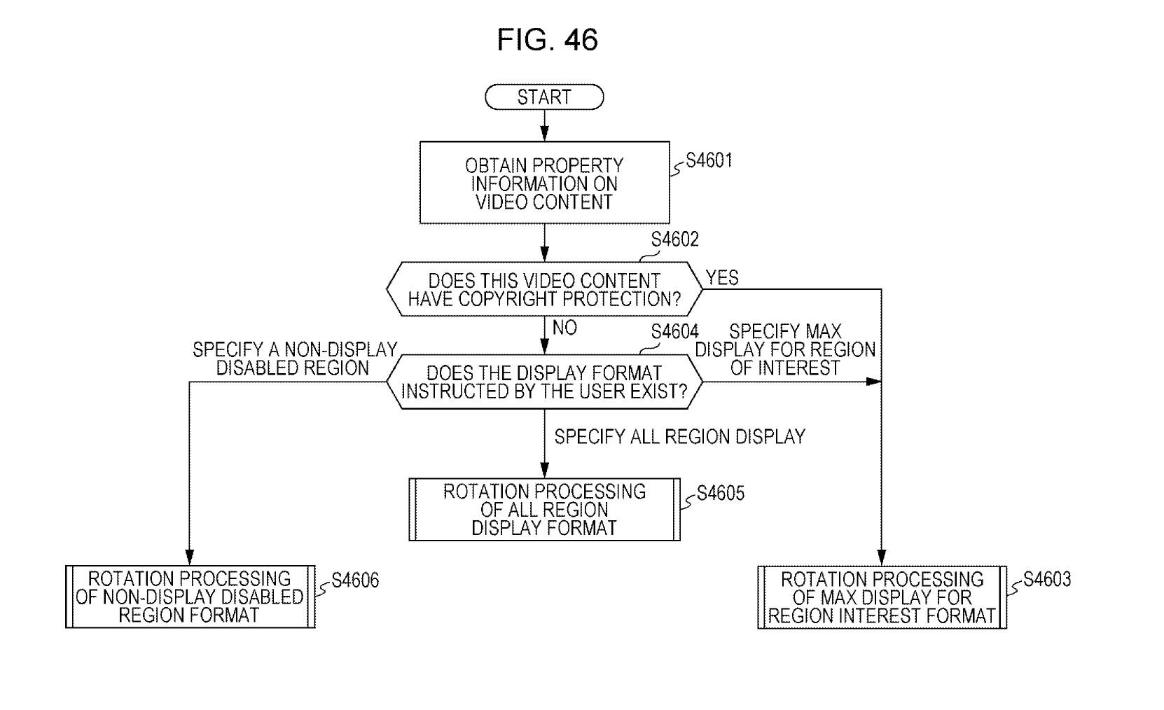

FIG. 46 is a flowchart illustrating a processing procedure to control the display format of video content at the calculating unit 120, when rotating the information processing device 100 (screen of the display unit 603). This processing procedure initiates for example, when it is detected that the main unit of the information processing device 100 is rotating on the rotation and installation mechanism unit 180, or when the triaxial sensor 515 detects a change in the rotation position of the main unit of the information processing device 100.

When rotating the information processing device 100 (screen of the display unit 603), first the calculating unit 120 obtains attribute information on the video content displayed on the screen (step S4601). The video content displayed on the screen is then checked whether it is protected content by copyright or the like (step S4602).

Here, when the video content displayed on the screen is content protected by copyright or the like (Yes in step S4602), the calculating unit 120 selects the display format to display the entire region of the video content so that the video content is not clearly seen at some arbitrary angle, as shown in FIG. 42 (step S4603).

Also, when the video content displayed on the screen is not content protected by copyright or the like (No in step S4602), checking of whether or not there is a display format specified by the user is performed (step S4604).

When the user selects the display format that displays the entire region of the video content, processing proceeds to step S4603. Also, when the user selects the display format that maximizes the display of the region of interest, processing proceeds to step S4605. Also, when the user selects the display format which does not display an invalid region, the processing proceeds to step S4606. Also, when the user does not select either display format, the display format, which has been set as the default value from among the three display formats described above, is selected.

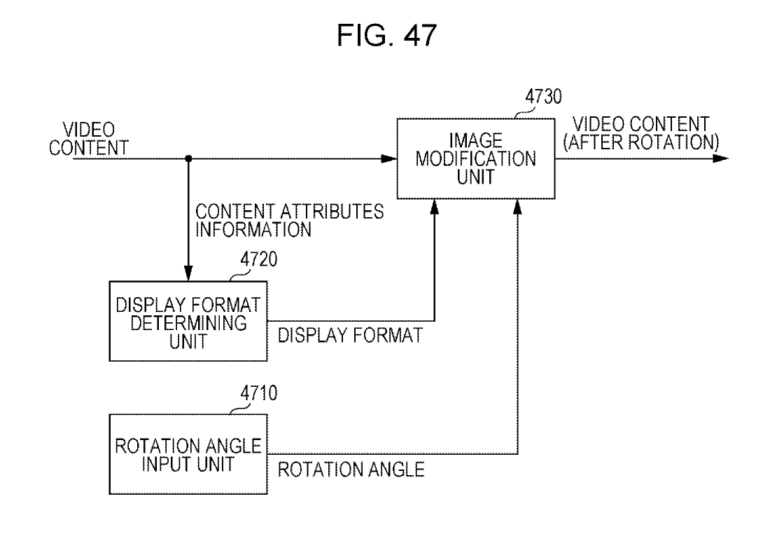

FIG. 47 illustrates an internal configuration for the calculating unit 120 to perform processing to adjust the display format of video content regarding the arbitrary rotation angle and transition process of the information processing device 100. The calculating unit 120 is equipped with a display format determining unit 4710, a rotation position input unit 4720, and an image processing unit 4730, and adjusts the display format of video content played from media, or received TV broadcasts.

The display format determining unit 4710 determines the display format following the processing method shown in FIG. 46, when video content is rotated regarding the transition process or some arbitrary rotation angle of the main unit of the information processing device 100.

The rotation position input unit 4720 inputs the rotation position of the main unit of the information processing device 100 (or the screen of display unit 602), which is obtained from the rotation and installation mechanism unit 180 and the triaxial sensor 515, through the input interface integration unit 520.

The image processing unit 4730 performs image processing of video content played from the received TV broadcasts or media, following the display format determined by the display format determining unit 4710, to be compatible with the screen of the display unit 603 slanting at the rotation angle input by the rotation position input unit 4720.

### G. Technology Disclosed in the Present Specification

The technology disclosed in the present specification can assume the following configurations.

(101) An information processing device, including a display unit; a user detection unit configured to detect a user present around the display unit; and a calculating unit configured to perform processing on operable objects displayed by the display unit, according to detection of a user by the user detection unit.

(102) The information processing device according to (101), wherein the user detection unit includes proximity sensors arranged in each of the four edges of the screen of the display unit, and detects a user present near each edge.

(103) The information processing device according to (101), wherein the calculating unit sets a user occupied region for each detected user and a shared region shared among users on the screen of the display unit, according to the arrangement of users detected by the user detection unit.

(104) The information processing device according to (103), wherein the calculating unit displays one or more operable objects as user operation targets, on the screen of the display unit.

(105) The information processing device according to (104), wherein the calculating unit optimizes operable objects in the user occupied region.

(106) The information processing device according to (104), wherein the calculating unit performs rotation processing on operable objects in user occupied regions in a direction to face the appropriate user.

(107) The information processing device according to (104), wherein the calculating unit performs rotation processing on operable objects that have been moved from the shared region or another user occupied region to a user occupied region in a direction to face the appropriate user.

(108) The information processing device according to (107), wherein the calculating unit controls the rotation direction when rotation processing is performed on operable objects, according to the position operated by the user regarding the center of the operable object, when a user drags an operable object between regions.

(109) The information processing device according to (103), wherein the calculating unit displays a detection indicator representing that a user is newly detected, when a user occupied region is set on the screen of the display unit for a user newly detected by the user detection unit.

(110) The information processing device according to (104), further including a data exchange unit configured to exchange data with user-owned terminals.

(111) The information processing device according to (110), wherein the data exchange unit performs data exchange processing with a terminal owned by a user, who was detected by the user detection unit, and wherein the calculating unit regenerates operable objects from data received from a user-owned terminal, in the appropriate user occupied region.

(112) The information processing device according to (104), wherein the calculating unit duplicates or divides operable objects in the user occupied region to which they will be moved, in accordance with the moving of operable objects between user occupied regions of each user.

(113) The information processing device according to (112), wherein the calculating unit displays the duplication of operable objects created as separate data in the user occupied region to which they will be moved.

(114) The information processing device according to (112), wherein the calculating unit displays the duplication of operable objects which becomes a separate window of an application that enables collaborative work among users, in the user occupied region to which they will be moved.

(115) An information processing method, including detecting users present in the surrounding region; and processing of operable objects to be displayed, according to the detection of a user obtained in the obtaining of information relating to user detection.

(116) A computer program written in a computer-readable format, causing a computer to function as a display unit; a user detection unit configured to detect a user present in near the display unit; and a calculating unit configured to perform processing of operable objects to be displayed on the display unit, according to the detection of a user by the user detection unit.

(201) An information processing device, including a display unit; a user position detecting unit configured to detect the position of a user in regards to the display unit; a user state detection unit configured to detect the state of a user in regards to the display screen of the display unit; and a calculating unit configured to control the GUI to be displayed on the display unit, according to the user state detected by the user state detection unit, and the user position detected by the user position detecting unit.

(202) The information processing device according to (201), wherein the calculating unit controls the framework and information density of one or more operable objects that become operation targets of a user, to be displayed on the screen of the display unit, according to the user position and user state.

(203) The information processing device according to (201), wherein the calculating unit controls the framework of the operable objects to be displayed on the screen, in accordance with whether or not a user is viewing the screen of the display unit.

(204) The information processing device according to (201), wherein the calculating unit controls the information density of operable objects displayed on the screen of the display unit, according to user position.

(205) The information processing device according to (201), wherein the calculating unit controls the selection of operable objects displayed on the screen of the display unit, according to whether the user is in a position where personal recognition can be made.

(206) The information processing device according to (201), providing one or more input methods for the user to operate operable objects displayed on the screen of the display unit, and wherein the calculating unit controls the framework of operable objects displayed on the screen, according to whether or not the user is in a state of operating the operable object by the input method.

(207) An information processing device, including a display unit enabling one or more input methods for the user to operate operable objects displayed on the screen of the display unit; a user position detecting unit that detects the position of a user in regards to the display unit; a user state detection unit that detects the state of a user in regards to the display screen of the display unit; and a calculating unit that optimizes the input method, according to the user position detected by the user position detecting unit, and the user state detected by the user state detection unit.

(208) The information processing device according to (207), wherein the calculating unit controls the optimization of the input method, according to whether the user is in a state of viewing the screen of the display unit.

(209) The information processing device according to (207), wherein the calculating unit optimizes the input method, according to the user position detected by the user position detecting unit, for the state when the user is viewing the screen of the display unit.

(210) An information processing device, including a display unit; a user position detecting unit configured to detect the position of a user in regards to the display unit, providing multiple distance detection methods to detect the distance from the screen of the display unit to the user; and a calculating unit that controls the switching of the distance detection method, according to the user position detected by the user position detecting unit.

(211) The information processing device according to (210), wherein in all cases the calculating unit turns on the function for the distance detection method to detect the distance to user who is far.

(212) The information processing device according to (210), wherein the calculating unit that detects the distance of a user who is near, and also turns on the function for the distance detection method with recognition processing, only within a distance range when a sufficient recognition accuracy can be obtained.

(213) An information processing method, including detecting the position of a user in regards to the display screen; detecting the state of a user in regards to the display screen; and calculating to control the GUI to be displayed on the display screen, according to the user position detected by obtaining information relating to the user position, and the user state detected by obtaining information relating to the user state.

(214) An information processing method, including detecting the position of a user in regards to the display screen; detecting the state of a user in regards to the display screen; and optimizing of one or more input methods for the user to operate operable objects displayed on the screen of the display screen, according to the user position detected by obtaining information relating to the user position, and the user state detected by obtaining information relating to the user state

(215) An information processing method, including detecting the position of a user in regards to the display screen; and switching of multiple distance detection methods that detect the distance from the display screen to the user, according to the user position detected by obtaining information relating to the user position.

(216) A computer program written in a computer-readable format, causing a computer to function as a display unit; a user position detecting unit configured to detect the position of a user in regards to the display unit; a user state detection unit configured to detect the state of a user in regards to the display unit; and a calculating unit configured to control the GUI to be displayed on the display unit, according to the user position detected by the user position detecting unit, and the user state detected by the user state detection unit.

(217) A computer program written in a computer-readable format, causing a computer to function as a display unit, enabling one or more input methods for the user to operate operable objects displayed on the screen of the display unit; a user position detecting unit configured to detect the position of a user in regards to the display unit; a user state detection unit configured to detect the state of a user in regards to the display unit; and a calculating unit configured to optimize the input method, according to the user position detected by the user position detecting unit, and the user state detected by the user state detection unit.

(218) A computer program written in a computer-readable format, causing a computer to function as a display unit; a user position detecting unit configured to detect a user position in regards to the display unit, providing multiple distance detection methods to detect the distance from the screen of the display unit to the user; and a calculating unit configured to control the switching of the distance detection method, according to the user position detected by the user position detecting unit.

(301) An information processing device, including a display unit; an object image obtaining unit configured to obtain images of objects to be displayed on the screen of the display unit; a real size obtaining unit configured to obtain information related to the real size of the objects to be displayed on the screen of the display unit; and a calculating unit configured to process the images of the objects, based on the real size of the objects obtained by the real size obtaining unit.

(302) The information processing device according to (301), further including a display capabilities obtaining unit configured to obtain information related to the display capabilities including screen size and resolution of the screen of the display unit, and wherein the calculating unit processes images of the objects to display in real size on the screen of the display unit, based on the display capabilities obtained by the display capabilities obtaining unit, and the real size of the objects obtained by the real size obtaining unit.

(303) The information processing device according to (301), wherein the calculating unit, when simultaneously displaying images of multiple objects, which are obtained by the object image obtaining unit, on the screen of the display unit, processes the images of the multiple objects so that the relation in size of the corresponding images of the objects is displayed correctly.

(304) The information processing device according to (301), further including a camera unit; and a real size estimating unit configured to estimate the real size of objects included in images taken by the camera unit.

(305) The information processing device according to (104), further including a camera unit; an image recognition unit configured to recognize faces of users included in images taken by the camera unit, and obtains face data; a distance detection unit that detects the distance to the user; and a real size estimating unit that estimates the real size of faces of the users, based on the distance to the user and face data of the user.

(306) An information processing method, including obtaining images of objects displayed on a screen; obtaining information related to the real size of the objects displayed on the screen; and processing of images of the objects, based on the real size of the objects obtained by obtaining information relating to the real size.

(307) A computer program written in a computer-readable format, causing a computer to function as a display unit; an object image obtaining unit configured to obtain images of objects to be displayed on the screen of the display unit; a real size obtaining unit configured to obtain information related to the real size of the objects displayed on the screen of the display unit; and a calculating unit configured to process the images of the objects, based on the real size of objects obtained by the real size obtaining unit.

(401) An information processing device, including a camera unit; a display unit; and a calculating unit configured to normalize images of users taken by the camera unit when displaying on the screen of the display unit.

(402) The information processing device according to (401), further including an object image obtaining unit configured to obtain images of objects to be displayed on the screen of the display unit, and a juxtaposed/superimposed pattern obtaining unit configured to obtain the juxtaposed/superimposed pattern so that images of the objects and images of the users are juxtaposed or superimposed on the screen of the display unit, wherein the calculating unit normalizes so that the relation in size and position is correct for the objects and images of the users, following the obtained juxtaposed/superimposed pattern, the objects and images of users after normalization are juxtaposed or superimposed.

(403) The information processing device according to (402), wherein the calculating unit performs control of the camera unit to normalize images of the users taken by the camera unit.

(404) The information processing device according to (401), further including a user face data obtaining unit configured to obtain face data on users taken by the camera unit, internal object face data obtaining unit that obtains face data in objects to be displayed by the display unit, wherein the calculating unit normalizes so that the relation in size and position of face data in the objects and face data of the users is correct.

(405) The information processing device according to (404), wherein the calculating unit performs control of the camera unit to normalize images of the users taken by the camera unit.

(406) An information processing method, including obtaining images of objects to be displayed on a screen; obtaining the juxtaposed/superimposed pattern for images of the objects and images of the users taken by a camera unit on the screen of the display unit; normalizing so that the relation in size and position of the objects and images of the users is correct; and image processing, following the obtained juxtaposed/superimposed pattern, of the objects and images of users after normalization are juxtaposed or superimposed.

(407) An information processing method, including obtaining face data of users taken by a camera unit; obtaining face data between objects displayed on a screen; and normalizing so that the relation in size and position of face data in the objects and face data of the users is correct.

(408) A computer program written in a computer-readable format, causing a computer to function as a camera unit; a display unit; and a calculating unit configured to normalize images of users taken by the camera unit, when displaying on a screen of the display unit.

(501) An information processing device, including a display unit configured to display video content on a screen; a rotation angle detection unit configured to detect the rotation angle of the screen; a display format determining unit configured to determine the display format of video content for some arbitrary rotation angle and a transition process of the screen; and an image processing unit configured to process images according to the display format determined by the display format determining unit, so that the video content is compatible with the screen slanting at the rotation angle detected by the rotation angle detection unit.

(502) The information processing device according to (501), wherein the display determination unit determines, including but not restricted to a display format in which a video content is prevented from being seen at all for some arbitrary rotation angle; a display format in which a region of interest within video content is maximized for each rotation angle; and a display format in which video content is rotated to eliminate invalid regions.

(503) The information processing device according to (501), wherein the display format determining unit determines the display format for some arbitrary angle and a transition process of the screen, based on the attribute information for the video content.

(504) The information processing device according to (501), wherein the display formation determination unit determines the display format so that video content is not completely seen for some arbitrary angle, for protected video content.

(505) An information processing method, including detecting the rotation angle of the screen; determining the display format of video content for some arbitrary rotation angle and a transition process of the screen; and processing of images according to the display format determined by obtaining information relating to the display format, so that the video content is compatible with the screen slanting at the rotation angle detected by obtaining information relating to the rotation angle.

(506) A computer program written in a computer-readable format, causing a computer to function as a display unit configured to display video content on a screen; a rotation angle detection unit configured to detect the rotation angle of the screen; a display format determining unit configured to determine the display format of video content for some arbitrary rotation angle and a transition process of the screen; and an image processing unit configured to process images according to the display format determined by the display format determining unit, so that the video content is compatible with the screen slanting at the rotation angle detected by the rotation angle detection unit.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device, comprising:
a display unit;
an object image obtaining unit configured to obtain images of objects to be displayed on the screen of the display unit;
a real size obtaining unit configured to obtain information related to the real size of the objects to be displayed on the screen of the display unit; and
a calculating unit configured to process the images of the objects, based on the real size of the objects obtained by the real size obtaining unit.

2. The information processing device according to claim 1, further comprising:
a display capabilities obtaining unit configured to obtain information related to the display capabilities including screen size and resolution of the screen of the display unit, and wherein the calculating unit processes images of the objects to display in real size on the screen of the display unit, based on the display capabilities obtained by the display capabilities obtaining unit, and the real size of the objects obtained by the real size obtaining unit.

3. The information processing device according to claim 1, wherein the calculating unit, when simultaneously displaying images of multiple objects, which are obtained by the object image obtaining unit, on the screen of the display unit, processes the images of the multiple objects so that the relation in size of the corresponding images of the objects is displayed correctly.

4. The information processing device according to claim 1, further comprising:
a camera unit; and
a real size estimating unit configured to estimate the real size of objects included in images taken by the camera unit.

5. The information processing device according to claim 1, further comprising:
a camera unit;
an image recognition unit configured to recognize faces of users included in images taken by the camera unit, and obtains face data;
a distance detection unit configured to detect the distance to the user; and
a real size estimating unit configured to estimate the real size of faces of the users, based on the distance to the user and face data of the user.

6. An information processing method, comprising:
obtaining images of objects displayed on a screen;
obtaining information related to the real size of the objects displayed on the screen; and
processing images of the objects, based on the real size of the objects obtained by obtaining information relating to the real size.

7. A computer program written in a computer-readable format, causing a computer to function as:
a display unit;
an object image obtaining unit configured to obtain images of objects to be displayed on the screen of the display unit;
a real size obtaining unit configured to obtain information related to the real size of the objects displayed on the screen of the display unit; and
a calculating unit configured to process the images of the objects, based on the real size of objects obtained by the real size obtaining unit.
